(19) United States
(12) Patent Application Publication
(10) Pub. No.: US 2017/0169511 A1
(43) Pub. Date: Jun. 15, 2017

(54) SYSTEMS AND METHODS FOR IMPROVED LOAN RESET, CUSTOMER RETENTION CAMPAIGNS AND RELATED PROCESSING

(71) Applicant: Keith Kelly, Arlington, VA (US)

(72) Inventor: Keith Kelly, Arlington, VA (US)

(21) Appl. No.: 15/443,074

(22) Filed: Feb. 27, 2017

Related U.S. Application Data
(63) Continuation-in-part of application No. 14/855,330, filed on Sep. 15, 2015.

(51) Int. Cl. G06Q 40/02

(52) U.S. Cl. CPC G06Q 40/025; G06Q 40/08

(57) ABSTRACT

A system and method are provided that process financial institution customer interface data in conjunction with facilitating a customer retention campaign involving loan reset offers for reset-eligible customers of a financial institution. The system may retrieve a listing of eligible loan data from a financial institution and generate proposed reset loan offers and unique, encrypted locator identifiers for each of the eligible customers. The system may automatically communicate offers and identifiers to each respective customer, who can review and accept a real-time loan reset offer using the system, thereby resulting in retained customers who might otherwise payoff existing loans in favor of refinancing with a third party. The system may also be used for generating single offers to single customers, and may be used to offer other financial products, such as pre-approved credit cards, to eligible customers.

### PRIORITY CLAIM AND REFERENCE TO RELATED APPLICATIONS

This application claims priority under all applicable laws, treaties and regulations, to pending U.S. application Ser. No. 14/855,530, titled SYSTEMS AND METHODS FOR IMPROVED LOAN RESET AND RELATED PROCESSING, filed on Sep. 15, 2015, the subject matter of which is incorporated by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

This invention relates to the field of banking systems and methods, financial systems and methods, mortgage systems and methods, loan systems and methods, restructuring systems and methods, tracking and analytics' systems and methods, and interest computation systems.

Particularly, this invention relates to loan processing and related processing, such as annuity redirection processing performed in conjunction with loan processing.

### BACKGROUND OF THE INVENTION

A lending institution, such as a bank, provides a loan to a debtor in return for periodic time payments at a set rate of interest. The time payments are due at predetermined payment intervals, typically every month, during the period or the term of the loan. The term is sometimes defined by the number of time payments. Part of each time payment made by the debtor is generally allocated to paying interest on the loan, and the remainder of the payment is allocated to reducing the amount owed, known as the principal balance of the loan, and any escrow deposits. Interest to be collected on the loan is often front loaded. This means that the portion of a payment, made by a debtor, which is allocated to interest will decrease over the term of the loan, while at the same time the portion of the payment applied to the principal will increase. The reduction in the principal balance by the time payments is known as amortization. Known methods of calculating interest rates and amortization payments are disclosed in “The Mathematics of Investing: A Complete Reference” by Michael Thomsett, pp. 23-40.

Financial loans (such as mortgages) may be classified as fixed-rate or variable-rate. In a fixed-rate loan, a prevailing interest rate at the time the loan is made determines the rate of interest for the entire term of the loan. In a variable-rate loan, a prevailing interest rate at the time the loan is made determines the initial rate of interest. However, at set dates the interest rate of a variable-rate loan is adjusted in accordance with a time-varying interest-rate index, such as the rate of interest payable on Treasury Bills.

Interest-rate indices typically fluctuate several times a year, and may fluctuate by substantial amounts during the term of a loan. Such changes in interest rates are beyond the variable-rate debtor's control, and may be to his or her advantage or detriment depending on whether the interest rate on the adjustment date is higher or lower than the mortgage's initial interest rate.

In the case of a mortgage loan, a mortgage servicer is an entity who is paid a fee to collect the payments from the mortgagor (borrower) and pay them to the mortgagee (lender). The fee collected is typically called a servicing income, servicing revenue, or servicing fee. There may be other terms for this fee. Mortgage servicing companies collect servicing fees as compensation for the collection and processing of mortgage payments.

A debtor having a fixed-rate loan may find that after receiving a loan at a fixed rate of interest, interest rates decrease substantially below the fixed interest rate associated with his or her loan. Naturally, the debtor prefers a loan with a low rate of interest so that the time payment amount will be as low as possible. Unfortunately, a drawback of a fixed-rate loan is that the debtor cannot automatically take advantage of decreases in interest rates. On the other hand, the fixed-rate debtor is not adversely affected by increases in interest rates which would negatively impact a variable-rate debtor.

To lower the mortgage payment in light of a decrease in interest rates, the mortgagor must refinance his or her loan. Refinancing a loan includes at least of the following steps: re-applying for the loan, re-qualifying for the loan, and signing a new loan agreement at the lower rate of interest. Refinancing of a loan involves a number of mandatory fees, such as fees paid to the lending institution, attorney's fees, and title searcher's fees. Therefore, refinancing is not cost effective to the debtor unless interest rates have decreased enough that savings from lower mortgage payments will offset the initial monetary expenditure of refinancing the mortgage. Mortgage servicing companies are adversely affected when mortgagors refinance their mortgages in order to take advantage of interest rate drops, because refinancing of a mortgage pays the mortgage in full thereby eliminating future earned interest on the mortgage and the accompanying servicing fee revenue.

In recent years par plus pricing has become very popular for refinancing mortgages. Par plus pricing is where a lender, in exchange for a higher rate of interest, provides a credit to the borrower which can be used to pay for the borrower's closing costs associated with refinancing. In essence, par plus pricing allows borrowers to lower the interest rates on their mortgages, through refinancing, without having to pay the associated fees at closing. This allows the mortgagor to lower his or her interest rate even if a small interest rate percentage drop would not have offset the monetary cost of traditional refinancing. Loan officers refinancing their current customers using par plus pricing are paid a commission on each refinance. A side effect of par plus pricing has been unusually high prepayment speeds on mortgages. High prepayment speeds negatively affect mortgage servicers and mortgage investors by lowering both the interest collected over time and the revenue generated through the mortgage servicing fee.

U.S. Pat. No. 5,878,404 is directed to a system and method for managing the amortization of a loan which automatically resets the rate of interest stored in memory in response to the debtor's election, yet holds the rate of interest fixed in the absence of such an election. In this patent application, a mortgage which can have its interest rate lowered without refinancing, as disclosed in U.S. Pat. No. 5,878,404, will be called a modifiable mortgage. The use of modifiable mortgages increases the customer retention rates for mortgage servicers and mortgage investors by eliminating the need to refinance mortgages in order to take advantage of lower interest rates. In essence, if a person had a mortgage whereby interest rates could be lowered without refinancing, such person may be less inclined to leave his or her current mortgage servicer.

Mortgage companies employ loan officers to originate mortgages. Compensation is paid to loan officers in the form of commissions for the origination of mortgages. Further, loan officers are typically paid a full commission when they refinance their current customers. When interest rates decline, par plus pricing provides loan officers the opportunity to earn a commission each time a customer refinances the same property. However, not all involved parties benefit from the refinancing of mortgages. Higher prepayment speeds adversely impact mortgage investors because their original investment is repaid earlier than expected. Servicing companies who collect payments on behalf of the investor also are adversely impacted because the servicing income generated is stopped when the loan is paid off.

A modifiable mortgage helps mortgage servicing companies retain their customers while at the same time helping to prevent mortgages from being paid off at faster than expected intervals. However, mortgage companies face a problem trying to get their salespeople to promote and originate (or sell) modifiable mortgages. The problem is that, under traditional compensation schemes, loan officers may earn less commission from modifiable mortgages than more conventional mortgage types. In particular, if a modifiable mortgage is offered to the borrower, a refinancing is less likely to occur and the loan officer does not receive additional compensation because a new refinanced loan is typically not originated. Loan officers therefore may not be incentivized to promote and sell modifiable mortgages because doing so may decrease the amount of income a loan officer could make when compared to selling other mortgage types, such as par plus pricing loans, which have a greater likelihood of being refinanced.

U.S. Pat. No. 7,292,995 is directed to a system and method for providing compensation to loan professionals. In this patent, a compensation program associated with a modifiable mortgage is disclosed which provides incentives to encourage a sales force to originate a modifiable mortgage. In one aspect of U.S. Pat. No. 7,292,995, the compensation program calculates an annuity to be paid to an appropriate sales force member based on the principal, interest, and/or service income of a modifiable mortgage. In another aspect of U.S. Pat. No. 7,292,995, the compensation program provides a commission calculation to be paid based on a triggering event such as, for example, each time the interest rate on a modifiable mortgage is lowered. The compensation program as disclosed in U.S. Pat. No. 7,292,995 may also include both the annuity compensation and the commission compensation as incentives to originate the modifiable mortgage.

### SUMMARY OF INVENTION

However, a variety of problems arise due to resetting mortgage rate or due to restructuring of finances. Firstly, the annuities that are due to an employee may differ. These annuities are typically structured wherein a part percentage is paid to a broker and a part percentage to the company or bank. These percentages may vary in cases of restructuring or resetting. Secondly, if a broker who is an employee leaves the bank or mortgage company, the annuities need to be redirected. Thirdly, the annuities need to be efficiently used by the bank or company.

Furthermore, in terms of restructuring or refinancing or resetting mortgage rates, the banks need to retain customers. Therefore, customer retention mechanisms need to be in place.

Accordingly, there is a need for systems and methods which provide mechanisms for handling annuities in instances of restructuring or refinancing or resetting mortgage rates and also for handling annuities in instances of employees of brokers leaving the bank or company.

Further, there is a need for systems and methods which provide mechanisms and processes for handling user initiated rate resets and loan modifications in a user friendly and interactive interface.

Accordingly, there is also a need for systems and methods for customer retention and customer acquisition based on aggregated analytics and tracking data.

There is a further need for systems and methods for integrating a loan rate reset systems and methods efficiently and rapidly into an existing financial institution, including systems and methods for enabling a financial institution to generate rate reset offers for all or a significant number of its customers who might be eligible for such offers. There is a further associated need for systems and methods for communicating such offers to customers in a secure and convenient manner and for enabling such customers to accept such offers and to execute any required documents to create a binding legal contract.

Illustratively, the systems and methods of the invention process customer interface data in conjunction with resetting a loan, the system comprises a processor coupled to a memory portion with the processor configured to execute programmed instructions stored in the memory portion. The system may include a communication portion that interfaces with a customer device to establish an electronic session over a network, and the electronic session including a plurality of exchanges of data between the processor and the customer device over the network and the memory portion. The processor, of the system, may perform processing including: (A) interfacing with the customer device, via the communication portion over an electronic network, to establish the electronic session between the processor and the customer device; (B) retrieving prior customer data, collected from prior interface with the customer over the network; (C) retrieving current loan data that relates to a current financial product possessed by the customer; (D) retrieving offered loan data that relates to an offered financial product, the offered loan data constituted by a collection of rules that constrain particulars of a loan under the offered loan data, the rules providing for stretches of parameters afforded by the offered loan data; (E) generating first prospect loan data based on (a) the offered loan data, (b) the prior customer data, and (c) the current loan data, and outputting the first prospect loan data to the customer device so as to render a prospect loan on the customer device in the form of graphics presented to the customer in the electronic session; (F) collecting, in the electronic session, current customer data regarding interfacing with the customer in the electronic session; and (G) generating second prospect loan data based on (a) the offered loan data, (b) the prior customer data, (c) the current loan data, and (d) the current customer data, and outputting the adjusted prospect loan data to the customer device in the electronic session, the adjusted prospect loan data output so as to render on the customer device in the form of graphics presented to the customer in the electronic session.

According to a further aspect of the invention relating to a customer retention campaign management capability provided by example loan reset interface systems disclosed herein, the systems and methods of the invention process financial institution reset-eligible loan and customer data in conjunction with facilitating a customer retention campaign in which the financial institution may cost effectively, and in mass, engage reset-eligible loan customers regarding proposed loans. An example system comprises a processor coupled to a memory portion with the processor configured to execute programmed instructions stored in the memory portion. The system may include a communication portion that interfaces with financial institution devices and with customer devices to establish an electronic session over a network, and the electronic session including a plurality of exchanges of data between the processor and the customer device over the network and the memory portion. The processor, of the system, may perform processing including: (A) interfacing with the financial institution devices and customer devices, via the communication portion over an electronic network, to establish the electronic session between the processor, financial institution devices, and customer devices; (B) retrieves reset-eligible loan/customer data from financial institution devices; (C) for each customer in the reset-eligible loan/customer data, generates a customer-specific proposed rate reset offer and generates a unique, customer-specific, locator identifier associated with each proposed rate reset offer for each customer; (D) facilitates communication of the proposed rate reset offer and unique locator identifier to each customer; (D) facilitates engagement of the customer with the LRI using the unique locator identifier; and performs processing related to the establishment of the new loan with interested customers.

The customer retention campaign capabilities of systems and methods according to this aspect reduces or eliminates the need for addition IT resources to integrate or facilitate the use of loan rate reset systems and methods that might result in retention of loan customers (borrowers). Such integration and facilitation may take place across the financial institutions large customer base, with each customer receiving a customized offer and with each customer provided with a secure online resource to view, accept the offer and to execute closing documents related to the offer. This aspect of the invention further permits financial institution customers, especially those on the verge of a traditional refinancing, to quickly and efficiently evaluate additional options available to them. This aspect further permits a financial institution to engage in large scale campaigns to offer other financial products, such as pre-approved loans and credit cards to customers who meet certain predetermined criteria. Such financial products can be offered and accepted in real-time and to large numbers of financial institution customers through the use of unique locators assigned to each customer to enable access to a customer-specific offer for such financial products.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a diagram showing aspects of loan reset-interface processing, in accordance with one embodiment of the invention.

FIG. 2 is a schematic diagram of a financial system that includes a loan reset-interface (LRI) system, in accordance with one embodiment of the invention.

FIG. 3 is a schematic diagram of the loan reset-interface system of FIG. 2 showing details of the analytics portion of FIG. 2, in accordance with one embodiment of the invention.

FIG. 4 is a further schematic diagram of the loan reset-interface system of FIG. 2 showing details of the memory portion of FIG. 2, in accordance with one embodiment of the invention.

FIG. 5 is high level flowchart showing processing performed by the loan reset-interface system, in accordance with one embodiment of the invention.

FIG. 6 is a flowchart showing in further detail the system performing processing to engage a customer regarding a loan reset, in accordance with one embodiment of the invention.

FIG. 7 is a flowchart showing in further detail the “engage customer to provide options and information for reset loan” processing FIG. 6, in accordance with one embodiment of the invention.

FIG. 8 shows the “processing to perform sale or transfer of an annuity associated with the reset loan” step of FIG. 5, in accordance with one embodiment of the invention.

FIG. 9 illustrates a first visual user-friendly graphical display of an additional aspect of the present invention providing for a one-click rate resetting or loan reconfiguring mechanism, in accordance with one embodiment of the invention.

FIG. 10 illustrates a further user-friendly graphical display of an additional aspect of the present invention providing for a one-click rate resetting or loan reconfiguring mechanism, in accordance with one embodiment of the invention.

FIG. 11 illustrates an administrative dashboard for a loan modification and cash out interface system and method, in accordance with one embodiment of the invention; and

FIG. 12 illustrates a tracking dashboard, in accordance with one embodiment of the invention.

FIG. 13 illustrates a further tracking dashboard, in accordance with one embodiment of the invention.

FIG. 14 is a diagram showing a further user interface, in accordance with one embodiment of the invention.

FIG. 15 is a diagram showing a further user interface, in accordance with one embodiment of the invention.

FIG. 16 is a diagram showing aspects of customer retention campaign (CRC) loan reset-interface processing, in accordance with one embodiment of the invention.

FIG. 17 is a schematic diagram of a financial system that includes a CRC loan reset-interface (LRI) system, in accordance with one embodiment of the invention.

FIG. 18 is a schematic diagram of the CRC loan reset-interface system of FIG. 17 showing details of the customer retention campaign management engine of FIG. 17, in accordance with one embodiment of the invention.

FIG. 19 is a further schematic diagram of the CRC loan reset-interface system of FIG. 7 showing details of the memory portion of FIG. 7, in accordance with one embodiment of the invention.

FIG. 20 is high level flowchart showing processing performed by the CRC loan reset-interface system, in accordance with one embodiment of the invention.

FIG. 21 is a flowchart showing in further detail the CRC LRI system performing processing to retrieve reset-eligible loan and customer data from a financial institution, in accordance with one embodiment of the invention.

FIG. 22 is a flowchart showing in further detail the processing to generate customer specific rate reset offers for each customer and a unique encrypted locator identifier associate with each rate reset offer in FIG. 20, in accordance with one embodiment of the invention.

FIG. 23 is a flowchart that shows the processing to communicate associated reset-offer and/or locator identifier to each customer of a financial institution in step 630 of FIG. 20, in accordance with one embodiment of the invention.

FIG. 24 illustrates a first visual user-friendly graphical display of an additional aspect of the present invention providing for a financial institution to upload reset-eligible loan and customer data to an example CRC LRI system.

FIG. 25 illustrates an example data set for reset-eligible loan and customer data from a financial institution uploaded to an example CRC LRI system in accordance with one embodiment of the invention.

FIG. 26 illustrates an example output data set including unique locator identifiers from an example CRC LRI system in accordance with an aspect of the invention.

FIG. 27 illustrates an example communication template for a financial institution to communicate locator identifiers and proposed loan reset in accordance with one embodiment of the invention.

FIG. 28 illustrates an example interface for financial institution customers to receive a proposed reset offer and associated locator identifier according to an aspect of the invention.

FIG. 29 illustrates an example user interface for a financial institution to create a single proposed reset offer, associated locator identifier and offer key according to an aspect of the invention.

FIG. 30 is illustrates a further user interface for a financial institution to create a single proposed reset offer, associated locator identifier and offer key, in accordance with an aspect of the invention.

FIG. 32 illustrates a user interface for financial institution customers to view a pre-approved credit card offer according to an aspect of the invention.

FIG. 33 illustrates a further user interface for customers to process a pre-approved credit card offer according to an aspect of the invention.

FIG. 34 illustrates a further user interface for customers to authorize payoff of an existing credit card as part of accepting a pre-approved credit card offer according to an aspect of the invention.

### DETAILED DESCRIPTION OF EXEMPLARY EMBODIMENTS

Hereinafter, aspects of loan reset-interface processing and associated systems in accordance with various embodiments of the invention will be described. As used herein, any term in the singular may be interpreted to be in the plural, and alternatively, any term in the plural may be interpreted to be in the singular. As used herein, “customer” and “user” have been used interchangeably, as a user may constitute a customer.

It is an object of the present invention to overcome the problems of the prior art by providing a system and method for managing financial products (including managing annuities associated with loans) pursuant to what is herein characterized as a “loan reset” (such loan reset including loan parameter resets for an auto loan, rate modifications on a mortgage, rate modifications on financing options, financing options, restructure of a financial product, or annuity redirection, for example) with respect to at least a customer, at least an employee, and/or at least a company.

In particular, the systems and methods of the invention provide a variety of processing related to resetting an existing loan, including control of graphical data and other data (presented to a customer) based on data collected from interfacing with one or more customers, to generate a “reset loan” in accordance with embodiments of the invention.

It is an additional object of the present invention to provide a system and method for computing annuity streams pursuant to loan parameter resets or rate modifications on mortgages or financing options (i.e. loan resets) with respect to at least a customer, at least an employee, and/or at least a company.

It is an additional object of the present invention to provide a system and method for handling user initiated rate resets and loan modifications (i.e. loan resets) in a user friendly and interactive interface.

It is another object of the present invention to provide a system and method for providing tracking data corresponding to a customer in relation to the customer's bank accounts and banking activity, customer's web interface activity, customer's web history, and similar parameters.

It is yet another object of the present invention to provide a system and method for providing analytics data corresponding to a customer in relation to the customer's bank accounts and banking activity, customer's web interface activity, customer's web history, and similar parameters.

It is still another object of the present invention to provide a system and method for using analytics' data for customer acquisition and customer retention.

It is an additional object of the present invention to provide a system and method for loan resetting according to system-defined parameters and/or user-defined parameters.

It is yet another object of the present invention to provide a system and method for facilitating a customer retention campaign involving loan reset offers to a multitude of a financial institutions customers who might be determined to be eligible for a rate reset offer.

It is yet another object of the present invention to provide a system and a method to facilitate customer retention campaigns that provide customer-specific real time offers to reset-eligible customers which offers can be securely encrypted, sent en masse to a financial institutions customers, and decrypted by interested customers who desire to review their respective offer in real time and to further facilitate the real-time acceptance of the offer and processing of necessary documents in real time, thereby retaining the customer by saving the loan for the financial institution.

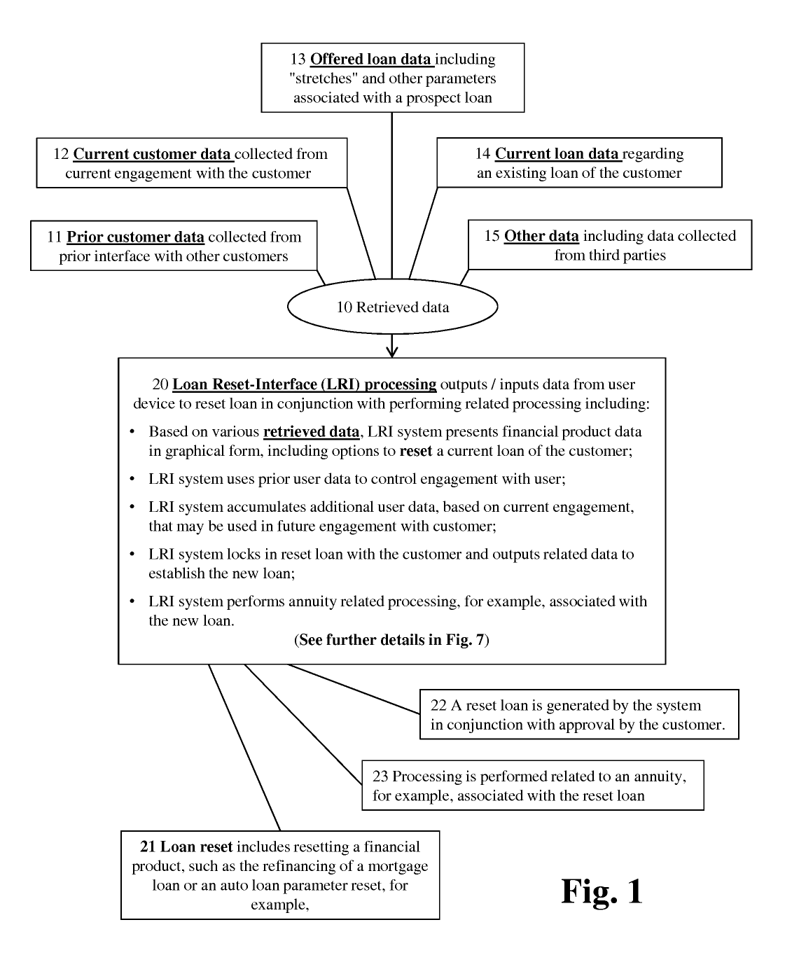

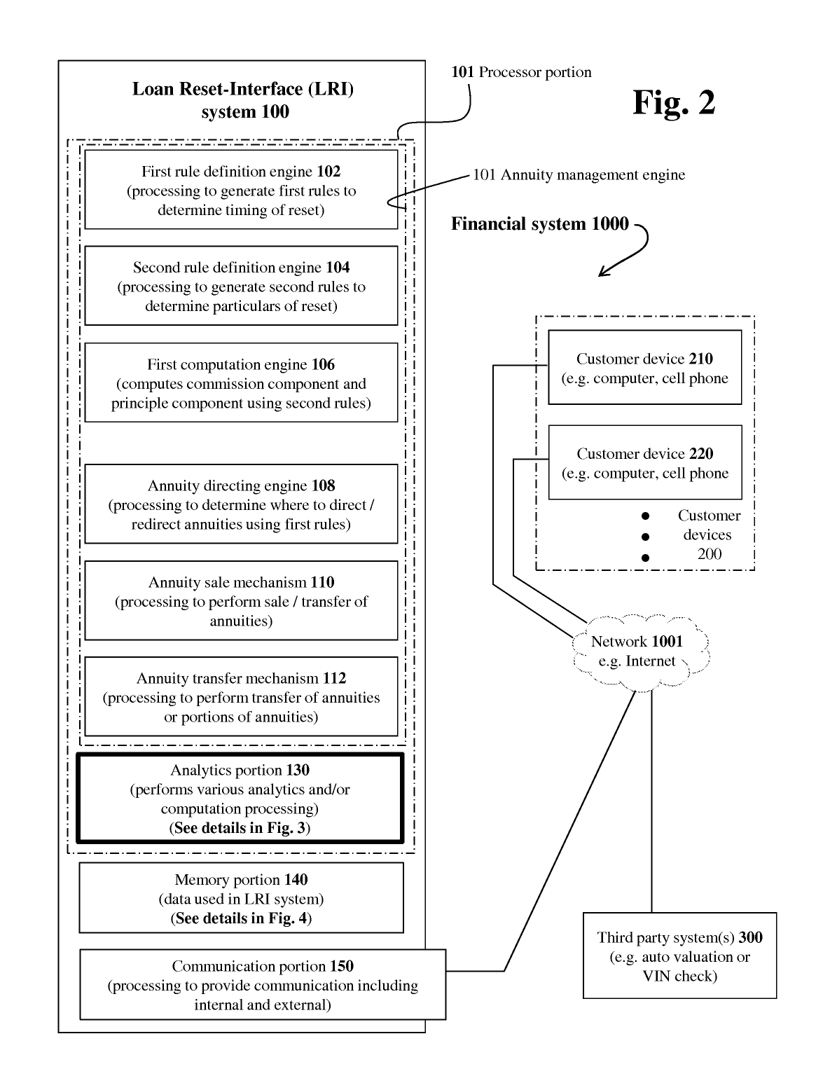

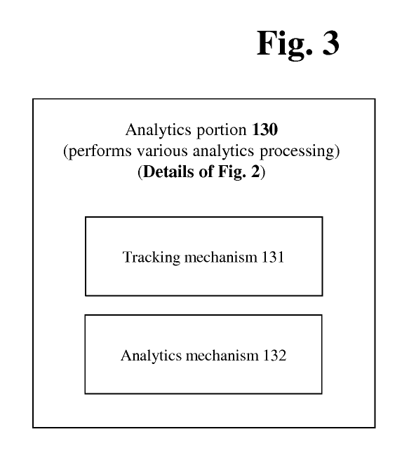

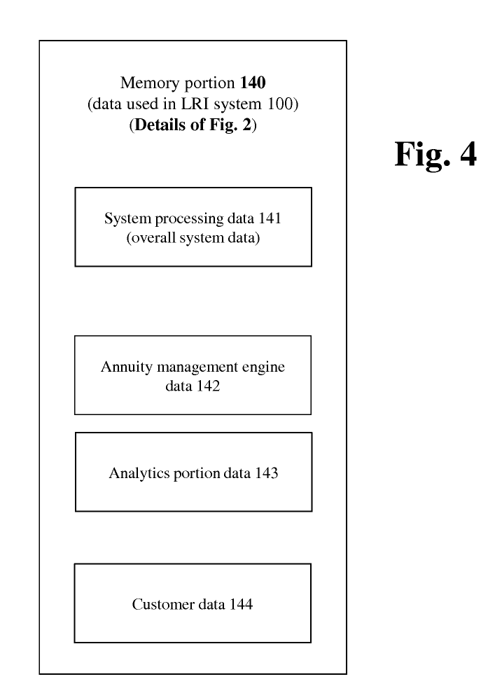

According to a first aspect of the present invention, as seen in FIGS. 1 and 2, there is provided an annuity redirection system and method.

FIG. 1 is a diagram showing aspects of loan reset-interface processing, in accordance with one embodiment of the invention. In accord with aspects of the invention as shown in item 20 of FIG. 1, the Loan Reset-Interface (LRI) processing outputs data to a user device, as well as inputs data from a user device, to reset a loan. In embodiments of the invention, this exchange of data may be performed over a suitable network, such as the Internet. In conjunction with this processing, the LRI system retrieves a variety of data from various sources. Based on this retrieve data, the LRI system presents financial product data in graphical form, including options to reset a current loan of the customer. In particular, the LRI system uses prior customer data to control future engagement with the customer. Such prior customer data might include bank records associated with the user. Further, the LRI system accumulates additional user data, based on current engagement with the user. This additional data that is accumulated may also be used in future engagement with the customer. Based on this various retrieved data, the LRI system locks in a reset loan with the customer and outputs various related data to establish the new loan, i.e. document the new loan. Lastly, the LRI system may perform annuity related processing, for example, that is associated with the new loan.

Accordingly, as shown in FIG. 1, a variety of retrieved data 10 may be utilized in such processing. The retrieved data 10 may include: the prior customer data 11 that is collected from prior interface with that particular customer and/or other customers; current customer data 12 that is collected from current engagement with the customer, such as in the particular web session; offered loan data 13 that may include “stretches” and other parameters associated with a prospect loan; current loan data 14 regarding the existing loan of the customer; and various other data 15 including data collected from third parties.

In an embodiment of the invention, the offered loan data may be constituted by a collection of rules the constraint particulars of a loan that is extended, to the customer, under the offered loan data. Further particulars are described below.

Illustratively, as reflected in item 21 of FIG. 1, a loan reset as enabled by the present invention may include resetting a financial product, such as the refinancing of a mortgage loan or resetting the parameters of an auto loan, for example. As reflected in item 22, a reset loan is generated by the system in conjunction with approval by the customer of such reset loan. Further, as reflected in item 23 of FIG. 1, additional processing may be performed related to an annuity, for example, that is associated with the reset loan. Further details are described below.

FIG. 2 is a schematic diagram of a financial system 1000 that includes a loan reset-interface (LRI) system 100, in accordance with one embodiment of the invention. The loan reset-interface (LRI) system 100 is so characterized herein in that it performs processing associated with both the reset of a loan and interfacing with the customer in conjunction with effecting such reset of the loan.

FIG. 3 and FIG. 4 are further schematic diagrams of the loan reset-interface system 100 of FIG. 2, in accordance with the invention. In particular, FIG. 3 is a block diagram showing the analytics portion 130 of the loan reset-interface system 100, in accordance with one embodiment of the invention. Further, FIG. 4 is a block diagram showing the memory portion 140 of the system 100.

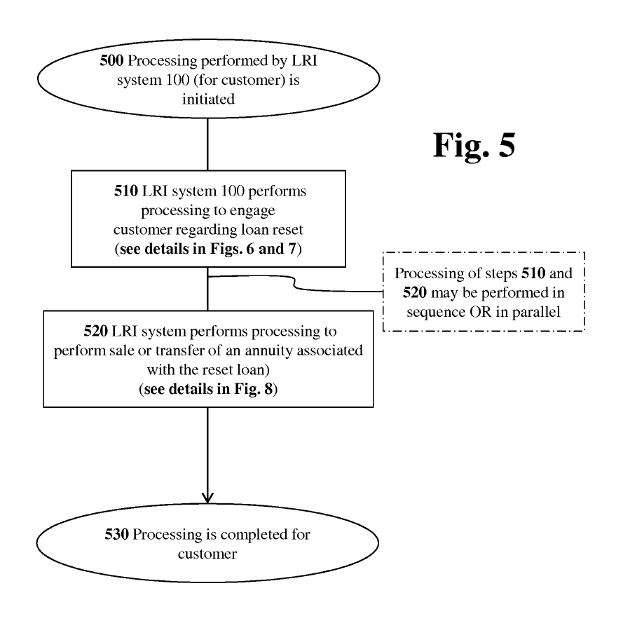

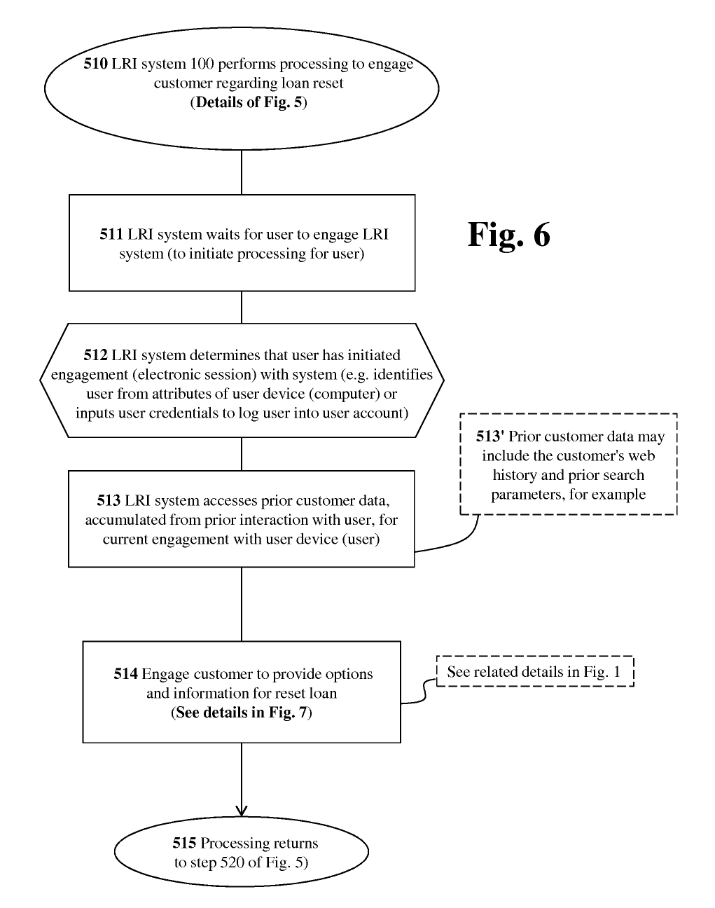

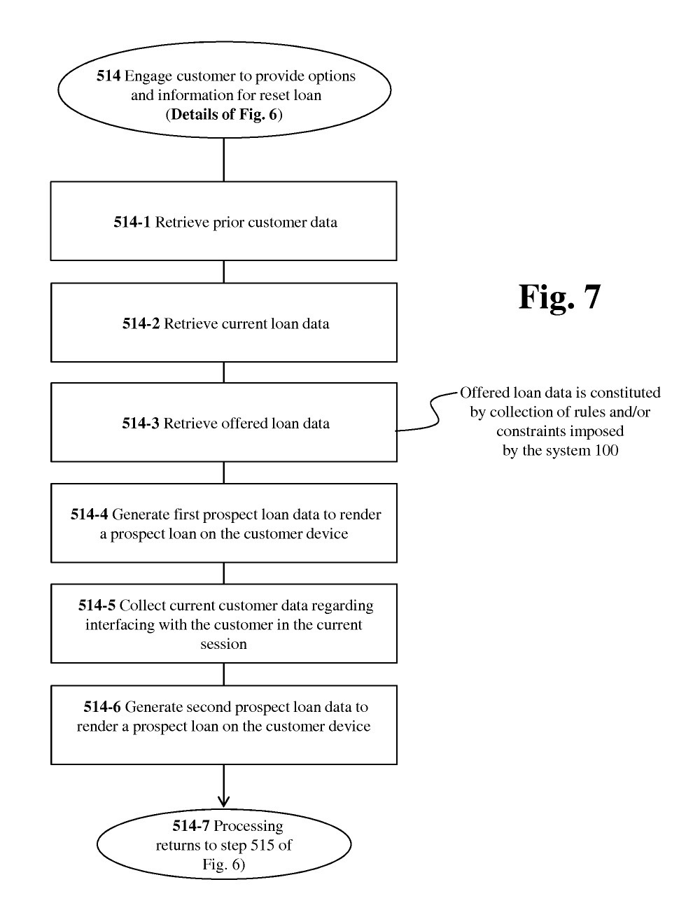

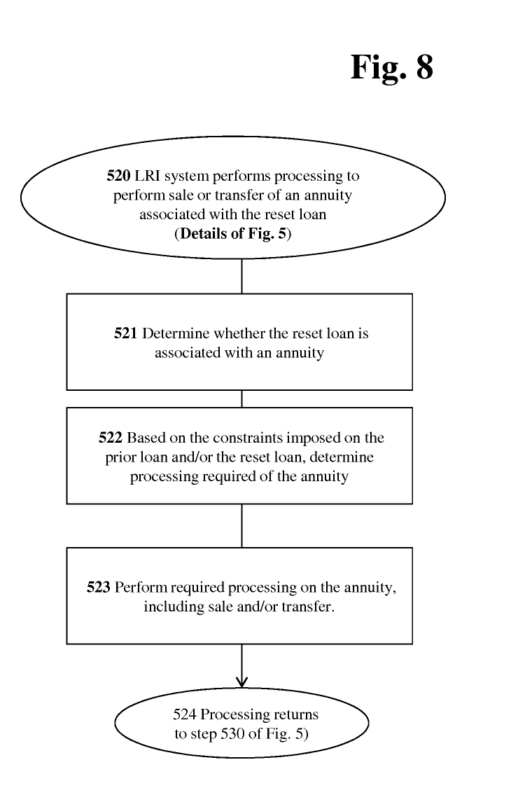

Further, FIG. 5 is high level flowchart showing processing performed by the loan reset-interface system 100, in accordance with one embodiment of the invention. Additionally, FIGS. 6-8 are further flowcharts showing the processing of FIG. 5 in further detail. Aspects of such processing are described below.

Hereinafter, further aspects of the invention will be described with reference to FIG. 2 and the financial system 1000 shown therein. The financial system 1000 includes the loan reset-interface system 100 as well as a plurality of customer devices 200. As shown in FIG. 2, customer devices include customer device 210 and customer device 220. However, it is appreciated that the customer devices may number in the hundreds, thousands or millions. Each customer device 200 may be in the form of a computer, a cellular phone, or some other electronic device. The system 100 communicates with the various customer devices 200 over a suitable network 1001. For example, the network 1001 might well be the Internet, or some other suitable network as further described below.

The financial system 1000 may also include one or more third-party systems 300. The system 100 may access such third-party systems over the network 1001 so as to retrieve relevant data from such third-party systems 300 in the processing performed by the system 100. Further details of such use of a third-party system 300 are described below.

As described above, the system 100 performs a wide variety of processing to interact with a user to reset a loan, such as an auto loan. Relatedly, it is appreciated that changes in any aspect of a loan (that is reset by a user) may well affect financial mechanisms that are tied or in some manner associated with such loan. In particular, changes in any aspect of a loan can also impact annuities that are related to the modified loan. Accordingly, the systems and methods of the invention provide both an interface and associated processing to effectively engage with a customer to reset a particular loan. In addition, the system 100 handles various processing that are associated with financial mechanisms that are tied to such a loan. The processing is described below with handling an impacted annuity that is tied to a reset loan. However, it is appreciated that the systems and methods of the invention are not limited to such particulars. That is, the processing described below with reference to an annuity may well be applied and utilized with some other financial mechanism, i.e. other than an annuity, that is impacted by a reset loan.

Accordingly, the system 100 includes an annuity management engine 101. The annuity management engine 101 performs various processing associated with an annuity that is impacted by the reset of a loan.

In accordance with at least an embodiment of this invention, the annuity management engine 101 is configured to restructure or reset annuities, which are associated with reset loans, in respect of pre-determined rules. As shown in FIG. 2, a first rule definition engine 102 defines a first set of rules in order to determine when the restructuring or redirection of annuities is to take place. Typically, annuities may be restructured or redirected when a customer resets or restructures his or her mortgage rates or loan rates, for example. Additionally, annuities may be restructured or redirected when an employee or broker leaves (or cuts association with) a bank or a company that he or she is associated with Annuities, typically, have at least two components; at least a commission component payable to a broker or an employee and at least a principal component payable to a bank or a company or a lending institution.

The system 100, i.e. the annuity management engine 101, further includes a second rule definition engine 104. The second rule definition engine 104 defines a second set of rules in order to determine how the restructuring of annuities is to take place. Typically, the second set of rules relates to percentages (or any pre-defined method) of split of annuity between broker or employee and company or bank. In at least one embodiment, the annuity management engine comprises a first computation engine 106 in order to compute at least a commission component and at least a principal component in correlation with the second set of defined rules. In at least one embodiment, the annuity management engine further comprises an annuity directing mechanism 108 in order to determine where to direct or redirect annuities in correlation with the first set of rules; i.e. when resetting or restructuring takes place or when an employee or broker leaves or becomes disassociated. In at least one embodiment, the annuity management engine further comprises an annuity sale mechanism 110 in order to allow a company or a bank that receives annuities to sell off the annuity. In at least one embodiment, the annuity management engine comprises an annuity transfer mechanism 112 in order to allow a company or a bank that receives annuities to transfer annuities or pre-defined portions thereof (as determined by the annuity directing mechanism and/or computation engine) to new employee(s) or existing employee(s) as bonus(es) or add-on(s).

Accordingly, various aspects of the annuity management engine 101 is described above, in accordance with at least one embodiment of the invention. Hereinafter, further aspects of the system 100 will be described including processing to reset a loan, which in turn may trigger the annuity processing describe above.

As shown in FIG. 2, the system 100 includes a processor portion 101, i.e. a processor. The processor portion 101 handles a wide variety of processing performed by the system 100. One aspect of such processing, as described above, is performed by the annuity management engine 101. In addition to the annuity management engine 101, the processor portion 101 (of the system 100) also includes an analytics portion 130. As described in detail below, the analytics portion 130 performs a variety of processing related to generating data and interfacing with a customer in conjunction with the reset of a loan associated with that customer. To that end, the analytics portion 130 performs a variety of processing and associated manipulation of data. Further aspects of the analytics portion 130 are described below with reference to FIG. 3.

The system 100 also includes a memory portion 140. The memory portion 140 stores a wide variety of data used in the system 100. In particular, the memory portion 140 stores data used by the annuity management engine 101 and the analytics portion 130. Further details of the memory portion 140 are described below with reference to FIG. 4.

As described above, FIG. 3 is a block diagram showing further details of the analytics portion 130, in accordance with one embodiment of the invention. FIG. 3 shows that the analytics portion 130 may include a tracking mechanism 131. In addition, the analytics portion 130 may include an analytics mechanism 132. Various further details of the analytics portion 130 are described below.

FIG. 4 is a block diagram showing further details of the memory portion 140, in accordance with one embodiment of the invention. The memory portion 140 is provided to store various data used in operation of the loan reset-interface system 100.

The memory portion 140 includes system processing data 141. This data includes operating data such as instructions on a computer readable medium to perform various processing described herein. The system processing data 141 may also be constituted by various data described herein as used in the processing of the invention.

The memory portion 140 also includes annuity management engine data 142. This data portion stores the various data that is used and/or generated by the annuity management engine 101.

The memory portion 140 also includes analytics portion data 143. This data portion stores the various data that is used and/or generated by the analytics portion 130.

Lastly, the memory portion 140 also includes customer data 144. The customer data 144 may include any of a wide variety of data that is associated with one or more customers. For example, such customer data 144 may be in the form of records that are respectively associated with a particular customer.

In accordance with further aspects of the invention and as described above, the analytics portion 130 includes a tracking mechanism 131. The tracking mechanism 131 is designed to track a customer's activity in terms of pre-defined parameters relating to banking and to provide tracking data per user. These parameters illustratively relate to a customer's bank accounts, nature of bank accounts, transaction types, transaction values, transaction nature, and the like and other banking activity. These parameters further relate to a customer's interaction and interaction with a bank in terms of physical banking, net banking (through a web-interface), phone banking, mobile banking, and the like. Click based analytics and mouse or activity tracking may be deployed in order to understand a customer's behavior of banking through a web-interface. Furthermore, a customer's web history and search parameters may be recorded in order to deeply understand customer-related parameters in order to profile a customer. Additional profiling mechanisms may be introduced and correlated with the above profiling system and method.

In accordance with at least yet another embodiment of this invention, the analytics portion 130 includes an analytics mechanism 132. The analytics mechanism 132 is configured to use tracked data per user in order to analyze user-based parameters based on pre-defined rules of analytics. This may be used to identify potential customers as well as to retain existing customers. Empirical data and statistical data can be derived from the tracked data in order to understand customer behavior. Trend analysis can be done using the analytics engine. This may aid in understanding customer's refinancing or financing needs, customer's refinancing or financing reasons, reasons due to which customer's that have been acquired or lost, and the like competitive and business intelligence.

Outputs from the tracking mechanism 131 along with the analytics mechanism 132 are illustratively used to identify customers with reset mortgages, customers who are considering a reset in their mortgage(s) or rates thereof, and customers who are defecting or likely to defect as part of a mortgage refinancing. In general, the tracking mechanism 131 along with the analytics mechanism 132 may be utilized to identify any of a wide variety of loans that may be good candidates for loan reset, in accordance with the invention. Such identification of good candidates are based on both attributes of the particular loan as well as attributes of the customer, including customer behavior.

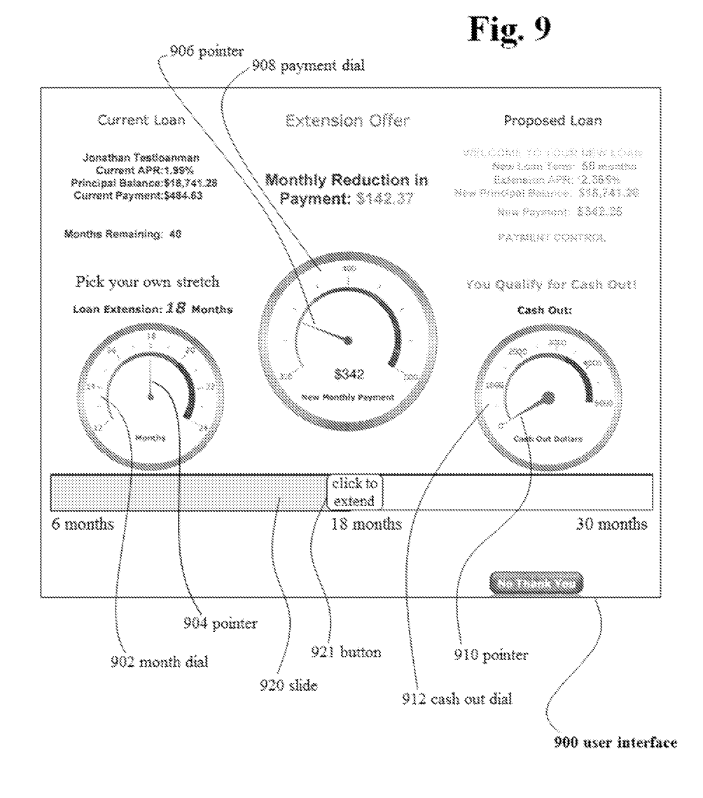

The analytics portion 130 performs a variety of processing in addition and/or in conjunction with the processing described above. In particular, the analytics portion 130 interfaces with a user to output various graphical displays to the user device along with inputting responsive content back from the user. Such engagement with the user may be performed via the communication portion 150 (of the system 100) communicating with a customer device 200 over the network 1001. Such engagement with a user is described further below and in particular with reference to the flowcharts of FIG. 6 and FIG. 7 and the processing shown therein, as well as the user interfaces of FIGS. 9-13. The communication portion 150 may be constituted by any suitable communication mechanism so as to transmit data from the loan reset-interface system 100 to the Internet. Relatedly, it is appreciated that each customer device 200 would of course be provided with respective communication portions so as to allow communication with the system 100 via the network 1001.

As described above, FIG. 5 is high level flowchart showing processing performed by the loan reset-interface system 100, in accordance with one embodiment of the invention. The processing of FIG. 5 starts in step 500, as shown. That is, in step 500, the system 100 initiates loan reset-interface processing for the customer.

After the process starts in step 500, the process passes to step 510. In step 510, the system 100 performs processing to engage a customer regarding a loan reset. In general, the processing of step 510 relates to retrieving a variety of data and presenting various options to the customer regarding a reset of a current loan of the customer. In accordance with embodiments of the invention, the various options may be presented to the customer in the form of graphics and other data. As described in detail below, such graphics may include dials representative of various parameters associated with a prospect loan reset, pointers to select values on such dials, sliders via which the customer may select values associated with a prospect loan reset and/or other graphical representations and indicia.

Further details of such processing are described below with reference to the flow charts of FIG. 6 and FIG. 7, as well as the user interfaces of FIGS. 9-13.

As shown in FIG. 5, after the processing of step 510, the process passes to step 520. In step 520, the analytics portion 130 effects further processing in view of the reset of a loan, which was performed in step 510. That is, in step 520, the analytics portion 130 may perform a sale and/or transfer of an annuity associated with the reset loan. This is in the case, as described above, in which an annuity is associated with the reset loan.

After step 520, the process passes to step 530. In step 530, the processing as illustratively performed by the analytics portion 130 is completed for that particular customer. However, it is appreciated that processing performed by the analytics portion 130, and in general the system 100, may be continuous given the many potential customers serviced by the system 100.

As shown in FIG. 5, the processing of step 510 and the processing of step 520 are illustrated as being sequential in accordance with one embodiment of the invention. However, it is appreciated that the invention is not limited to such particulars. Rather, it is appreciated that the processing of step 510 may be performed in parallel with the processing of step 520—or in some other manner performed in conjunction with the processing of step 520. Indeed, it may be the situation that the particular prospect loan presented to the customer may in some manner be dependent on sale or transfer of an annuity associated with the current loan of the customer.

FIG. 6 is a flowchart showing in further detail the system 100 performing processing to engage a customer regarding a loan reset. That is, FIG. 6 is a flowchart showing in further detail the processing of step 510 (of FIG. 5). As shown in FIG. 6, the processing starts in step 510 and passes to step 511.

In step 511 of FIG. 6, the system 100 waits for a user to engage the system so as to initiate processing. Then, in step 512, the system 100 determines that a user has indeed engaged the system 100 in a session. Such engagement may well be in the form of an electronic session such as the user interfacing with the system 100 via web browser over the Internet. Such engagement may include the system 100 identifying the user from attributes of the particular user device, such as a computer. Such engagement may further include the system 100 inputting user credentials to log the user into a user account. Such user credentials might include a username and password, for example. It is appreciated that the identification of the particular user allows that various information associated with that particular user may then be retrieved and used—by the system 100 to engage the user in the session.

After the processing of step 512, the process passes to step 513. In step 513, the system 100 accesses prior customer data accumulated from prior interaction with the particular user. This retrieved data may then be used for affective engagement with the user in the current session. Then, the process passes to step 514.

The processing of step 514 is illustratively performed, in particular, by the analytics portion 130 of the system 100. In step 514, the analytics portion further engages the customer to provide a variety of options and information related to a prospect loan, i.e., a “prospect loan” meaning a loan offered by the system 100 (to the user) that constitutes a reset of a current loan possessed by the user. Accordingly, it is in the processing of step 514 that the analytics portion 100 generates the various user interfaces as shown in FIGS. 9-13.

Further details of the processing of step 514 (of FIG. 6) are described below with reference to FIG. 7.

After the processing of step 514 in FIG. 6, the process passes to step 515. In step 515, the processing returns to FIG. 5, and specifically passes to step 520 of FIG. 5.

FIG. 7 is a flowchart showing in further detail the “engage customer to provide options and information for reset loan” processing of step 514 of FIG. 6. As shown in FIG. 7, the processing starts in step 514 and passes to step 514-1.

In step 514-1, the loan reset-interface system 100 retrieves prior customer data, collected from prior interface with the customer over the network. Then, in step 514-2, the system 100 retrieves current loan data that relates to a current financial product possessed by the customer. In other words, this current financial product is the loan the user once to reset. Then, the processing passes to step 514-3.

In step 514-3, the loan reset-interface system 100 retrieves offered loan data that relates to an offered financial product. In accordance with an embodiment of the invention, the offered loan data may be constituted by a collection of rules that constrain particulars of a loan under the offered loan data, the rules, for example, providing for stretches of parameters afforded by the offered loan data. In other words, as characterized herein, “offered loan data” may be constituted at least in part by a collection of parameters. The offered loan data constrains such parameters to run a limited window, i.e. a limited stretch of values. Further, the offered loan data may well provide constraints between the interrelationship of the various parameters they go to make up the offered loan data. After the processing of step 514-3, the processing passes to step 514-4.

In step 514-4, the loan reset-interface system 100 generates first prospect loan data based on (a) the offered loan data, (b) the prior customer data, and (c) the current loan data, and outputs the first prospect loan data to the customer device so as to render a prospect loan on the customer device in the form of graphics presented to the customer in the electronic session.

Then, in step 514-5, the system 100 performs collecting, in the electronic session, current customer data regarding interfacing with the customer in the electronic session. Then, the process passes to step 514-6. In step 514-6, the loan reset-interface system 100 generates a second prospect loan data based on (a) the offered loan data, (b) the prior customer data, (c) the current loan data, and (d) the current customer data. Further, the system 100 outputs the adjusted prospect loan data to the customer device in the electronic session, the adjusted prospect loan data is output so as to render on the customer device in the form of graphics presented to the customer in the electronic session.

After step 514-6, the processing is performed by the system 100 passes to step 514-7. The processing then returns to step 515 of FIG. 6.

According to a further aspect of the present invention, FIGS. 9-13 show various user interfaces generated and displayed by the system 100. Such interfaces provide a user-friendly environment for effective engagement of the user-initiated loan modification system, which is provided by the system 100.

FIG. 8 shows the “processing to perform sale or transfer of an annuity associated with the reset loan” step of FIG. 5, in accordance with one embodiment of the invention. As shown, the process starts in step 520 and passes to step 521.

In step 521, the loan reset-interface system 100 determines whether the reset loan is associated with an annuity. Then, in step 522, based on the constraints imposed on the prior loan and/or the reset loan, the system 100 determines if processing of the annuity, which is associated with the reset loan, is required. Then, in step 523, the loan reset-interface system 100 performs required processing on the annuity, including sale and/or transfer. The processing then passes to step 524. In step 524, the processing returns to step 530 of FIG. 5)

Various other related processing is describe herein.

FIG. 9 illustrates a first visual user-friendly graphical display of an additional aspect of the present invention providing for a one-click rate resetting or loan reconfiguring mechanism system and method.

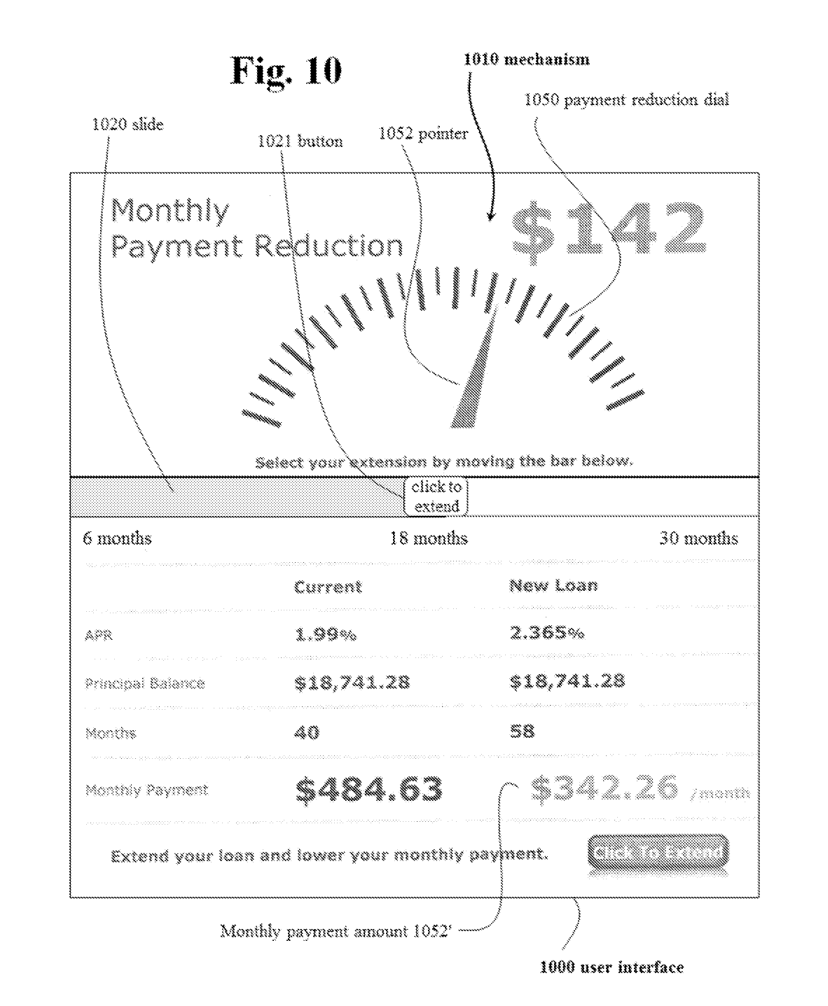

FIG. 10 illustrates a second user-friendly graphical display of an additional aspect of the present invention providing for a one-click rate resetting or loan reconfiguring mechanism system and method.

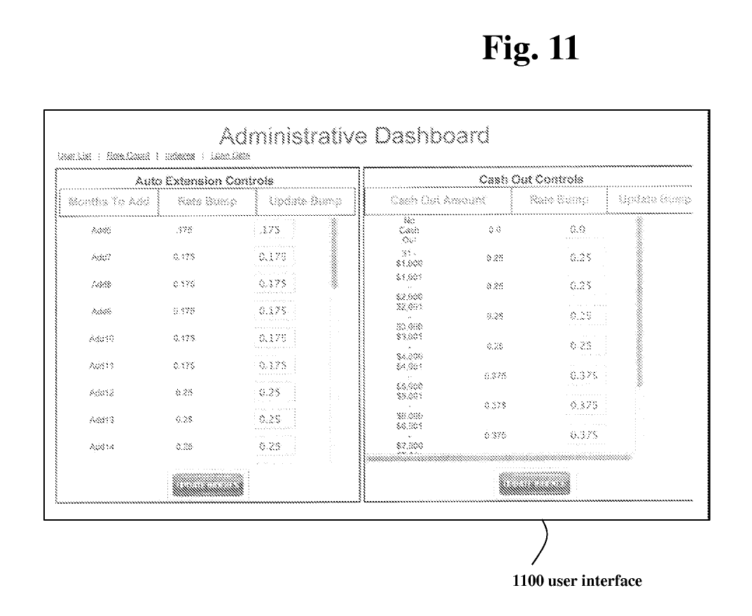

FIG. 11 illustrates an administrative dashboard for the system and method of the loan modification system and method.

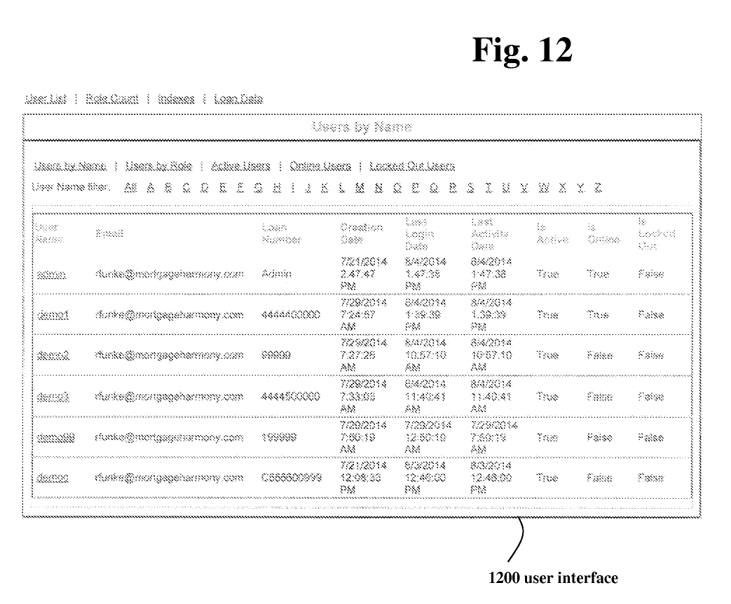

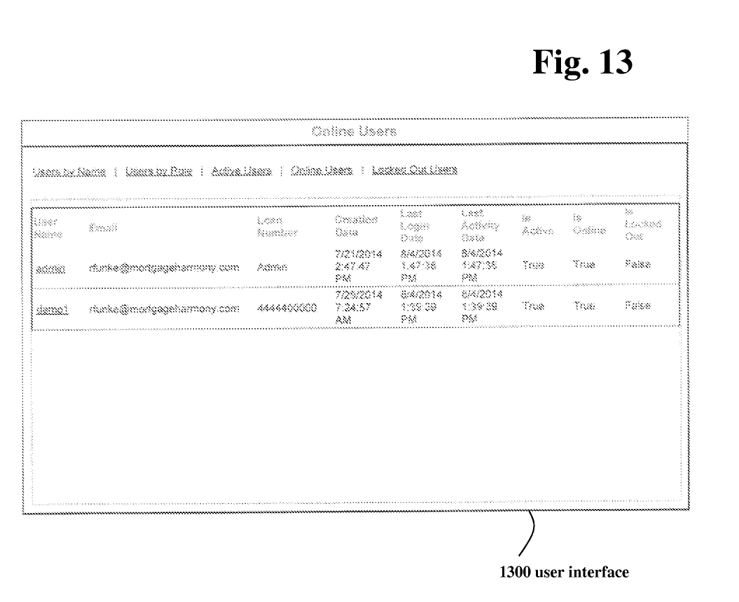

FIG. 12 and FIG. 13 illustrate a tracking dashboard, in accordance with one embodiment of the invention.

Hereinafter, further particulars of the various user interfaces of FIGS. 9-13 will be described in further detail.

In accordance with further aspects of this invention, as shown in FIG. 10, a one-click resetting or reconfiguring mechanism 1010 is configured to provide a user interface in order to allow a customer to reset or reconfigure a loan or mortgage in a one-click manner. In at least one embodiment, the resetting of reconfiguration of loans is related to car loan extensions. The one-click mechanism 1010 (shown in FIG. 10) stores user details upon login and prompts a user-friendly graphical display to allow a customer to reset or reconfigure a loan. This graphical display is a dashboard interface with a plurality of parameters that can be reset or reconfigured. The analytics portion 130 may constitute, in part, a second computation engine that computes other parameters which change based on user-defined changes. These other computed parameters can also be seen live as and how the user selects to reset or reconfigure at least one parameter. These parameters may be selected from a group of parameters consisting of term extension parameter, cash out amount parameters, interest rate parameters, and the like. Parameters such as yield rate and/or risk factors are system defined and play out on the user-defined parameters in order to change the corresponding other parameters to be visually showcased on the user-friendly graphical display.

In at least one embodiment, the described visual user-friendly graphical displays provide at least one sliding bar or pointer (904, 906, 910, 1052) as shown in FIG. 9 and FIG. 10 of the accompanying drawings.

The pointer (904, 906, 910, 1052), in this case, or a slider in any such other graphical user display is an adjustable interface which allows a user to adjust at least one parameter relating to the loan. Typically, this parameter is one of the key parameters relating to time period, rate of interest, desired monthly payment, cast out option, and similar such parameters. Change(s) in at least one of these user-selected or user-variable parameters results in changes in the other associated parameters relating to the same loan and/or the same customer. These changes follow pre-defined formulae and/or rules. Therefore, according to a non-limiting exemplary embodiment, a change in term of repayment results in changes in interest rate(s), monthly payment or installment(s) amount, and similar such parameters which are also instantaneously displayed on the graphical user display.

In the graphical user display of FIG. 9 of the accompanying drawings a first dial 902 is calibrated with time in months over which a loan is to be or can be paid. In a first embodiment, the first pointer 904 is user-configurable, in that, a customer or a user can slide the pointer to a choice of time period that is desirable. A second dial 908 is calibrated with desired payments to be made per time interval (per month) which is depicted by the second pointer 906. Additionally, a third dial 912 displays the cash out amount of the customer by means of a third pointer 910. The second dial 908 and the third dial 912 is communicably coupled to the first dial 902 by operation of the analytics portion 130, in accordance with one embodiment of the invention, which is pre-configured and shows corresponding changes in the second dial 908 and the third dial 912 pursuant to changes in the first dial 902.

In a further embodiment, the second pointer 906 is user-configurable, in that, a customer or a user can slide the pointer to a desired payment amount. This second dial 908 is calibrated with payments to be made per time interval (per month) which is depicted by the second pointer 906. A first dial 902 then depicts time intervals (months) required for the loan to be offset depending upon choice of payment amount per time interval (month). Additionally, a third dial 912 displays the cash out amount of the customer by means of a third pointer 910. The first dial 902 and the third dial 912 are communicably coupled to the second dial 908 by operation of the analytics portion 130, in accordance with one embodiment of the invention, which is pre-configured and shows corresponding changes in the first dial 902 and the third dial 912 pursuant to changes in the second dial 908.

In a third alternative embodiment, the third pointer 910 is user-configurable, in that, a customer or a user can slide the pointer 910 to a cash out amount of choice that is desirable. This third dial 912 is calibrated with cash out amounts relating to a customer which are depicted by the third pointer 910. A first dial 902 then depicts time intervals (months) required for the loan to be offset depending upon cash out amount of the third pointer 910. Additionally, the second dial 908 is calibrated with payment amounts to be made per time interval (per month) which is depicted by the second pointer 906. The first dial 902 and the second dial 908 are communicably coupled to the third dial 912 by operation of the analytics portion 130, in accordance with one embodiment of the invention, which is pre-configured and shows corresponding changes in the first dial 902 and the second dial 908 pursuant to changes in the third dial 912. Also as seen in FIG. 10, the pointer 1052 is user-configurable allowing the user to slide or move the pointer 1052 to a desired cash out amount on the payment reduction dial 1050. The modified monthly payment is displayed in the monthly payment amount section 1052′. The user can also move the loan extension button 1021 along the loan extension slide 1020 interface.

As described above, changes in any aspect of the loan can also impact annuities related to the modified loan. These changes are recorded and provided to the annuity management engine 101 which computes, tracks, and assigns any modifications, resetting or redirecting or reconfiguration of annuities. Entities which are affected in case of a non-limiting exemplary embodiment of car loan resetting include, but are not limited to: loan originator such as a broker or car dealership which sold the car; company providing the software to banks; the bank or financial institution; the bank manager or branch of bank associated with the loan; the website which referred the customer, and similar such entities.

FIG. 11 provides an admin user interface 1100 which works in combination with the interfaces provided in FIG. 9 and FIG. 10. Specifically, an admin user can add and edit interest rate increases for calculating a new modified loan based on the number of months added, the amount of cash out. These loan modification adjustments are made on top of other loan calculations based on the standard rates the bank might have and the credit profile of the customer. For example, a bank may provide or already have in place with a customer a four (4.0%) percent interest rate on a thirty six (36) month automobile loan. The same customer would be able to interact with one or more interfaces (see FIG. 9 and FIG. 10) and create modified loan parameters. As previously discussed, the system would enable the customer to extend the term (months), seek a specific monthly payment amount, or seek cash out. In such instance, the system of the present invention would modify the 4% rate or the banks then current rate for modified loans based on credit profile and recalculate the new interest rate and payment. The 4.0% interest rate might see an increase of 0.25% for adding 12 months (as seen in FIG. 11) and an additional 0.25% for taking $3,000.00 in cash out. The system would take these admin entered interest rate bumps and would update the payment term, monthly amount—and provide back to the user in real time on the user interface display (FIG. 9 and FIG. 10).

The system also allows the user to process the loan modification through the interface including processing of approval documents and related approvals. The system can track any commission or annuity adjustments for the modified loan. Finally, the system can be tied into related third party data prior to acceptance of loan modifications. For example, the loan modification could be tied into a database (e.g. the third party system 300 of FIG. 1) for automobile valuations to set limits on loan amounts and cash out amounts for vehicles based on value. Further, the system can be tied to vehicle or VIN checks for verification of unreported accidents or repossessions as well as credit reporting agencies to determine credit ratings as they impact the interest rates, interest rate bumps, and cash out limits.

Furthermore, these changes are recorded by the tracking mechanism and analytics' mechanism of this invention. This, further coupled with intelligence, aids in identifying customers' interest quotient in the services or loan modification option, customers who are inclined to reset their interest rates, customers who are inclined to defect for refinancing, and similar such parameters. This can further aid banks to provide tailor made resets instead of standard resets on interest rates.

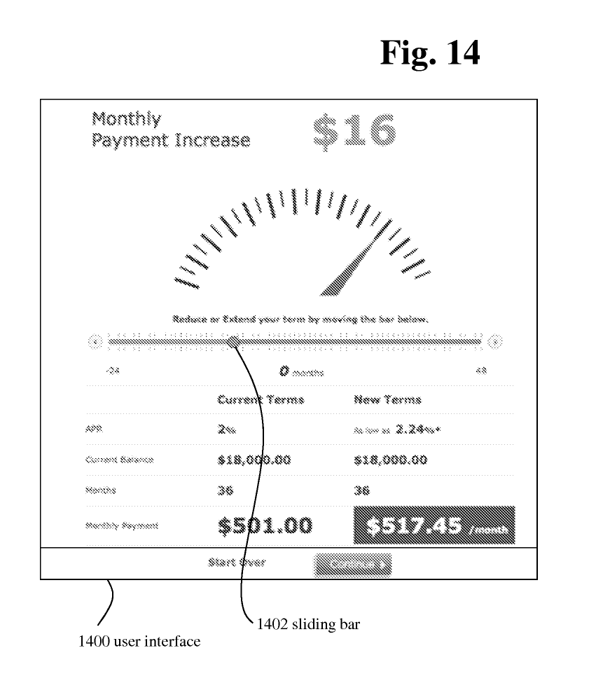

FIG. 14 is a diagram showing a further user interface, in accordance with one embodiment of the invention. The user interface 1400, as generated by the loan reset-interface system 100, provides an added ability to not only extend the term of the loan, but also provide the sliding bar 1402 to reduce the term of the loan to allow the customer additional customization choices. In addition, the loan reset-interface system 100 provides choices to ask the customer to input their current loan criteria (current interest rate, loan amount, number of months remaining, current payment, credit score estimate and year/make of automobile, for example) to calculate the interest rates which will display when the borrower uses the system 100. Once the customer finishes selecting their new terms (payment and interest rate and possibly cash out), the system 100 then creates a lead by asking the customer to input their name, email, phone number best time to call. The system then provides an “Apply Now” web link to the loan reset-interface system 100—whereby all of the inputs the borrower, i.e. customer, inputted and the choices the borrower makes with the term adjustment and cash out adjustment are fed into an online application (provided by the loan reset-interface system 100) to begin the loan application process.

The reduction in term can also apply to existing loans loaded onto the loan reset-interface system 100, i.e. for retention efforts in addition to the term extension and cash out options.

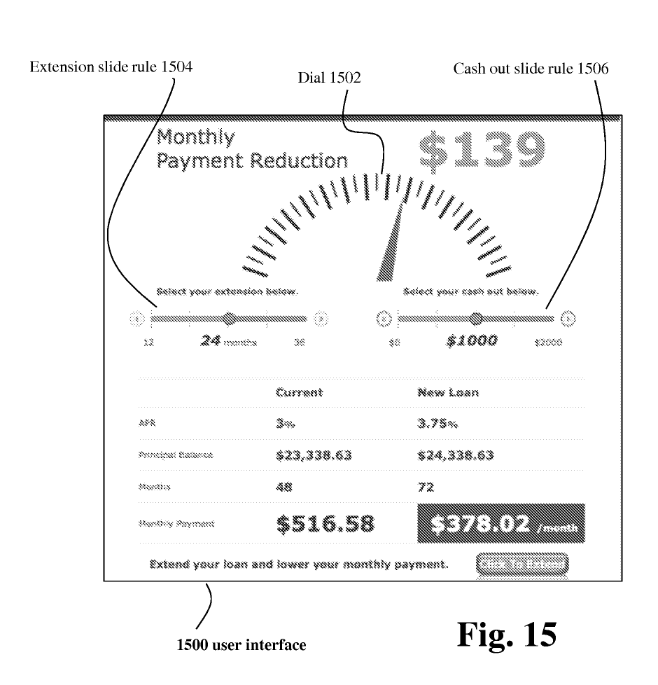

FIG. 15 is a diagram showing a further user interface, in accordance with one embodiment of the invention. As shown, the user interface 1500, as generated by the loan reset-interface system 100, includes a single dial 1502, which reflects monthly payment. However, the user may vary the position of the dial 1502, i.e. may vary the monthly payment, through manipulation of both the extension slide rule 1504 and the cash out slide rule 1506. Accordingly, such arrangement provides an enhanced approach to vary parameters associated with a loan.

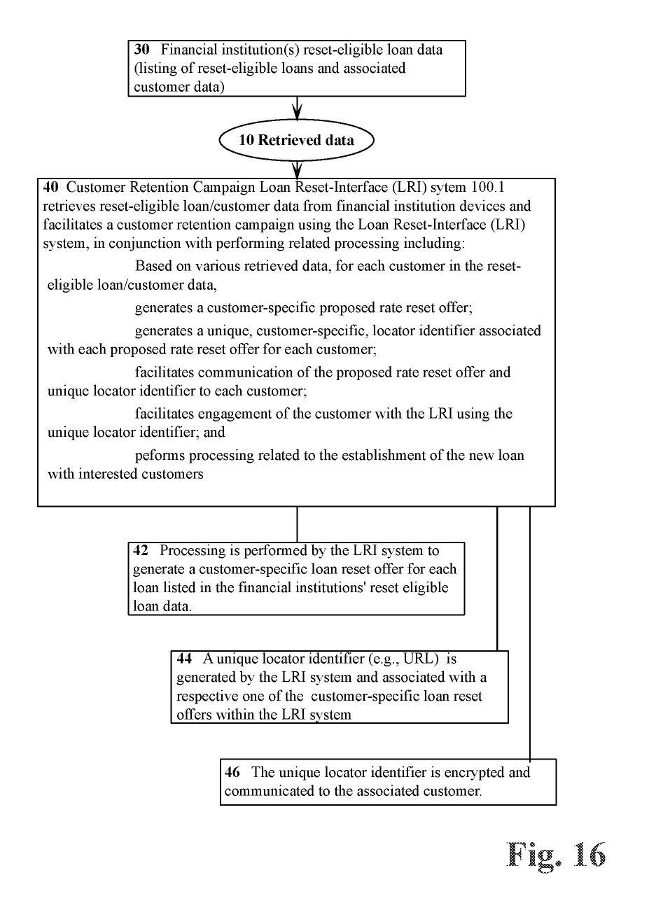

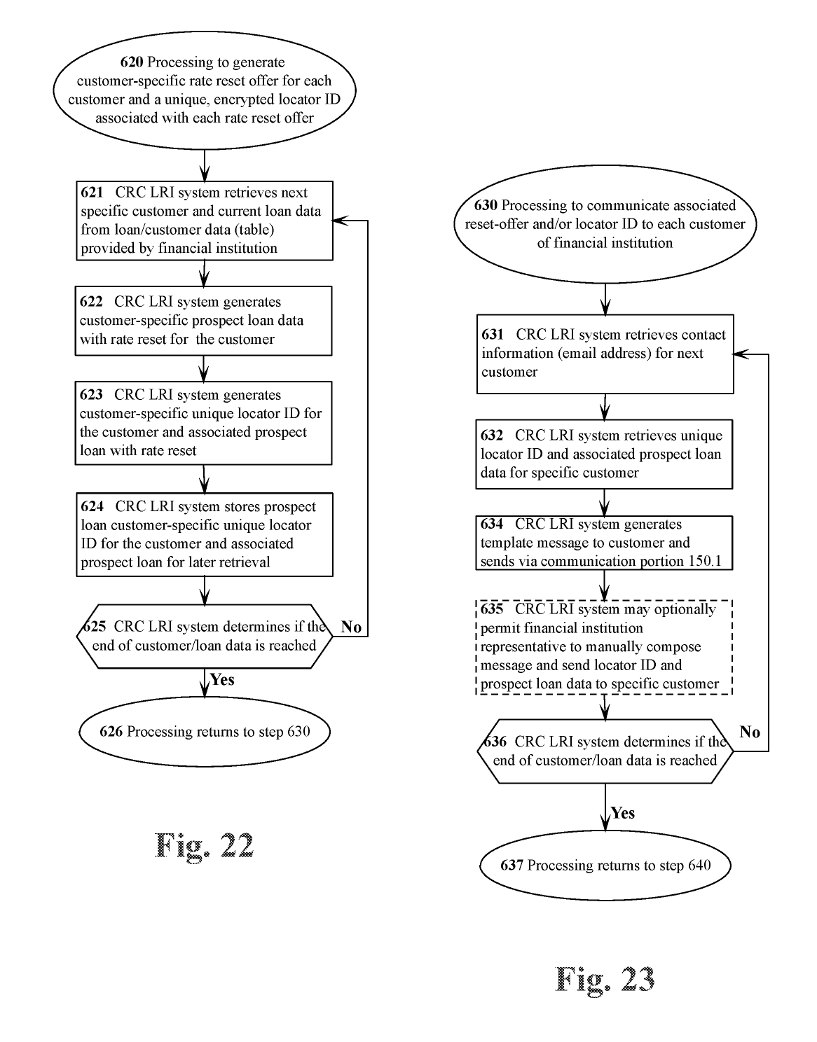

In accordance with further aspects of the invention, the loan reset-interface system 100 may include several methods for receiving data from financial institutions (FIs) or other entities. In accordance with one embodiment of the invention, as explained below in more detail with reference to FIGS. 16-33, the system 100 may receive customer data from a financial institution whereby the customer clicks a button on their online banking, such as where their loan resides. The loan (i.e. mortgage or car loan, for example) may be provided with a “Reset” Button next to presented loan data, thus providing an indication that a particular loan has a reset feature. When the borrower clicks the button, the pertinent existing loan data is transferred to the loan reset-interface system 100 in one long string of XML data (real time) upon the borrower click. The existing data may be loaded onto the system 100 for the borrower to compare against other available options.

In at least one embodiment of this invention, a referral management solution is provided wherein referrals from websites, third party dealers, lead generators, and the like are to be evaluated and commissions offered, thereto, are to be computed in accordance with user or customer defined resetting or reconfiguring mechanisms.

The software and system of embodiments of the invention perform numerous calculations and processes including: (1) New Loan Term: Months Remaining+Months Added; (2) Extension APR: Current APR+CO Bump+Added Mo Bump; (3) New Principal Balance: Current UPB+Cash Out; (4) New Payment: New Principal Balance.times.Extension APR/New Loan Term; (5) Monthly Reduction in Payment: Current Payment-New Payment. These calculations and processes are run in real time by handling various variables and formulas.

By way of example, the loan formula for calculating a monthly payment is set forth below where M is the monthly payment, P is the mortgage principle, I is the monthly interest, and N is the number of months of payments

M=P[I(1+I).sup.N]/[(1+I).sup.N−1]

However, there are numerous variables that can change the monthly payment (M) including: the interest rate (I); the principal (P); and the number of remaining monthly payments (N). Some of those variables include: [0118] 1. Current APR (Current interest rate) [0119] 2. Interest rate Increase based on number of months extended (rate bump) [0120] 3. Interest rate increase based on cash out (Cash out rate bump) [0121] 4. Extension APR (new interest rate) [0122] 5. Months Remaining (current months remaining) [0123] 6. Range of Months Added (1-36 months, FI determines range) [0124] 7. New Loan Term (calculated Months Remaining+Months Added) [0125] 8. Range of Cash Out Offer (0-$5,000, FI determines range) [0126] 9. Principal Balance (current remaining loan balance) [0127] 10. New Principal Balance (current remaining loan balance+cash out) [0128] 11. New Payment (Loan balance.times.Extension APR/New Loan Term) [0129] 12. Monthly Reduction in Payment (Current Payment-New Payment) [0130] 13. Loan Extension (Number of months selected from range)

The loan reset-interface system 100, through the programmed instructions in the software, is able to adjust, calculate, or determine the numerous variables based on user selected options, administrative established values, standard or real time market values, or calculated values, for example. These variables and values are then processed through the formula to determine the critical values the user wants to know such as monthly payment, new term, interest rate, or available cash out. The critical values are then translated into data sent to the user interface module of the software for conversion into a graphic display of the critical values. Accordingly, a gauge of the system is that as depicted in FIG. 9 and FIG. 10—displaying the critical values to the user. The gauge's range is variable and may be based on a predetermined (pre-calculated) worst case and best-case scenario as determined by the loan reset-interface system 100. For example, the worst case (least reduction of payments) is based on the borrower accepting the minimum number of months (and accepting a maximum cash-out if cash-out is allowed). The best case scenario may be based on the borrower accepting the maximum stretch (and no cash-out if cash-out is offered). The minimum and maximum stretch are determined based on client preferences that are stored within the system. These two scenarios also bring in the desired interest rate bumps that are determined and set by the administrative user (bank) which are also stored within the software application or system. Increments are typically set at $5 (small indicia) and $10 (large indicia).

In accordance with one or more embodiments of the current invention, a New Loan Term is calculated and stored by the software through the formula and the determined variables. The New Loan Term calculation is triggered by a specific event whereby the borrower elects to extend the term of their loan. Extending the Loan Term means the borrower is adding additional months to the time that the loan amount from the financial institution is paid in full. By way of example, but not to limit the claimed invention, a borrower has an existing loan with 40 months remaining until the current loan amount is paid in full. The borrower elects to add an additional 18 months to the time the loan amount from the financial institution is paid in full. The software calculates the New Loan Term of 58 months, determines the appropriate interest rate (I), any fees, and using the formula the software calculates the monthly payment (M) and stores the new values in the database. The software recognizes the calculation of the New Loan Term of 58 months and automatically, in real time displays the new term in the New Loan Term field on the user interface screen and the new monthly payment (M) on the user interface.

In accordance with another embodiment of the current invention, the Extension APR or interest rate (I) for an extended loan is calculated and stored by the software. The Extension APR calculation is triggered by a specific event whereby the borrower elects to extend the term of their loan and or take cash out. Extending the Loan Term means the borrower is adding additional months to the time that the loan amount from the financial institution is paid in full. When an extension occurs, banks can increase the standard interest rate by adding an interest bump to the interest rate.

In general, it is appreciated that a particular loan of a user is represented by data in a suitable database. For example, the data might be stored in the database associated with a financial institution maintaining the particular loan and/or in the memory portion 140 (FIG. 4) as described herein—such as in a suitable data record, for example. In accordance with aspects of the invention, this data, which is representative of an actual loan (of a customer), may not be varied in the course of a customer/user interfacing with the loan reset-interface system 100 to explore reset options. However, the actual data representing the loan would be varied upon the customer accepting a reset of his or her current loan, i.e. so as to secure a reset loan. Accordingly, in the case of a reset that includes a cash out option—the data of the original loan vis-a-vis the data representing the reset loan would indeed be changed based on where (in the course of selecting the particulars of the reset loan) the user indeed positioned the dial, slider, or other user interface mechanism. Accordingly, the manipulated position of such user interface mechanism does indeed bring about the real world change in data between the original loan vis-a-vis the reset loan.

Further, in accordance with embodiments of the invention, it is appreciated that data, which is representative of the actual loan, may indeed be varied in the course of a customer/user interfacing with the loan reset-interface system 100 to explore reset options. Such variance might be constituted by data (in the data record that represents the current loan of the customer) representing behavior of the customer. For example, this behavior might be mouse clicks, web pages visited, or other parameters as described herein. Accordingly, the customer exploring reset options (via the processing described herein) might indeed bring about a real world change in the data that represents his or her current loan. Furthermore, such data might be used by the loan reset-interface system 100 to alter future reset options provided to the customer in the various processing as described herein. For example, if a user is observed to be heavily exploring reset options (i.e. much activity)—then an APR or duration of a reset option offered to the customer might be less favorable vis-a-vis a case where the customer infrequently explored reset options. The basis for such decisioning performed by the loan reset-interface system 100 might rest in that the “much activity” scenario is indicative of the customer resetting (her loan) even in the absence of a more favorable duration or APR, for example.

As an example of an Extension APR, using a borrower with a current APR of 1.99% where the borrower elects to add an additional 18 months to the time the loan amount from the financial institution is paid in full. The software determines or calculates the New APR of 2.365% and stores the new value in the database. The New APR reflects a 3/8.sup.th risk premium (1.99%+0.375=2.365%) which is calculated using the standard borrower rate (1.99%) plus any additional rate adjustments or bumps as set by the admin user (see FIG. 11). The software recognizes the calculation of the New APR and automatically, in real time displays the new amount in the New APR field on the user interface screen. The software also uses the formula above to calculate any changes to the new monthly payment (M) based on the Extension APR and displays on the user interface screen. For example, if a borrower has a principal balance of $18,741.28 and elects to add an additional 18 months to the current remaining term of 40 months totaling 58 months for the loan amount to be paid in full. As a result the New APR is 2.365% (1.99%+0.375%=2.365%). The software calculates the New Payment of $342.26 ($18,741.28.times.2.365% compounded/58 months=$342.26) and stores the new value in the database. The software recognizes the calculation of the New Payment of $342.26 and automatically, in real time displays the new amount in the New Payment field on the user interface screen.

In another example, using a borrower with a current APR of 1.99% and a credit score of 620, where the borrower elects to add an additional 18 months to the term of the loan amount. In such an example, the software calculates the New APR of 2.5% and stores the new value in the database. The New APR reflects a 1/2 risk premium ((Extension Risk of 3/8.sup.th and Credit Score Risk of 1/8.sup.th) to obtain the 2.5% rate value (1.99%+0.375+0.125=2.500%). The software recognizes the calculation of the New APR and automatically, in real time displays the new amount in the New APR field on the user interface screen. Through the real time automated adjustment of the APR the software is able to provide Loan Level Borrower Specific Price Adjustments. The software also uses the financing formula to calculate any changes to the new monthly payment (M) based on the Extension APR and any other risk related components of the loan and displays on the user interface screen.

The system of the present invention can also determine the New Principal Balance as calculated and stored by the software. The New Principal Balance calculation is triggered by a specific event whereby the borrower selects the Cash Out option. Cash Out means the borrower is adding to their principle (P) loan amount and increasing the amount owed to the financial institution. As an example, if a borrower has an existing loan with an outstanding balance of $25,000.00 and selects a Cash Out option in the amount of $2,000.00. The software calculates the New Principal Balance of $27,000.00 and stores the new principal value in the database. The software recognizes the calculation of the New Principal Balance of $27,000.00 and automatically, in real time displays the new amount in the New Principal Balance field on the user interface screen. The software also uses the financing formula to calculate any changes to the new monthly payment (M) based on the New Principal Balance of the loan and displays on the user interface screen.

In accordance with another embodiment of the current invention, a user may seek a Monthly Reduction in Payment which can be calculated and stored by the software. The Monthly Reduction in Payment calculation is triggered by a specific event whereby the borrower seeks to lower their monthly payment which corresponds to an extension in the term of their loan. The user may also elect to take cash out as part of this process. Extending the Loan Term means the borrower is adding additional months to the time that the loan amount from the financial institution is paid in full. Cash Out means the borrower is adding to their loan amount and increasing the amount owed to the financial institution. Depending on the servicing requirements, the current invention calculates the new payment based on the existing principal balance, the balance after the borrower's next payment at the existing rate, or the balance after two payments made at the existing rate.

The following example is offed to illustrate, but not to limit the claimed invention. In this example the borrower has a current payment of $484.63. The borrower elects to add an additional 18 months to the current remaining term of 40 months totaling 58 months for the loan amount to be paid in full. Using the financing formula and the adjusted interest rates and the new term the New Payment is $342.26. The software calculates the Monthly Reduction in Payment of $142.37 and stores the new value in the database. The software recognizes the calculation of the Monthly Reduction in Payment of $142.37 and automatically, in real time displays the new amount in the Monthly Reduction in Payment field on the user interface screen.

In a preferred embodiment, the user interface includes a term extension slide or user initiated input with the scale or indicia in Months allowing the user to extend or slide the term in monthly increments. The slide beginning and ending points are based on the minimum and maximum stretch (calculated on each loan). The system may also provide a cash-out feature or element on the user interface. Such feature may be presented as a cash-out slide where the slide increments are at $500 and the slide may range from $0 to MaxCashOut. The MaxCashOut variable is determined or provided per each loan from the client or bank which has the loan.

In many instances, a new interest rate needs to be determined based on the various variables determined by user selection and bank or institution criteria. The system determines the new interest rate based on current institution interest rate settings. The invention provides several solutions to calculate a new offer rate. One solution allows for the software to take the borrower's current interest rate and adjust the offer rate by adding or subtracting to the current rate based on the borrower's election of extending their term, electing to take cash out, or both. Another embodiment provides a rate offer whereby the system can extract current interest rates from the institutions website and post the rate based on the borrower's election of extending their term and or taking cash out and or both.

Based on loan level information the software can also automatically identify risk components and calculate an adjusted interest rate. The interest rate is calculated based on a predefined index, plus a margin. The premium or discount for borrower related risk factors are added or subtracted. The index and margin are populated manually and then automatically applied to all appropriate loans. The index can also be populated automatically using a predefined interface with the desired index. The appropriate risk adjustments are pre populated and applied automatically as risk components are recognized. Ultimately, the software takes all the interest rate information and determines a final or total interest rate it uses in the financing formula to determine the monthly payment or new term.

The software, through use of the formulas, variables, indexes, real time and pre-set values can determine the monthly payment, term, interest rate, and principal based on any factors changed by the user or set or changed by the institution. The final values are determined and can be stored in the system and transmitted to the user to display on the user interface. The value can be displayed as text but can also be translated into the meter or slide bar feature of the user interface as depicted in FIG. 9 and FIG. 10, for example. Ultimately, users can utilize the user interface and system to determine new loan terms that might better fit their current need or situation. Once the user identifies a loan which suits their needs they can select to initiate the loan adjustment. In such instances, the bank or institution is notified of the users desire to change a current loan to a modified loan with the selected parameters (payment, interest rate, new term, cash out) as established through the interface and software. If the user is not a current bank customer, the software allows the system to capture user information to provide the bank as a new lead generation tool for the bank to contact and offer a loan with the knowledge of the user's preferred modified loan values.

FIG. 16 is a diagram showing aspects of customer retention campaign (CRC) loan reset-interface (LRI) processing, in accordance with one embodiment of the invention. In accord with aspects of the invention as shown in item 40 of FIG. 16, the CRC processing outputs data to a user device, as well as inputs data from a user device, to reset a loan. In conjunction with this processing, the LRI system retrieves a variety of data from various sources as explained above with regard to FIG. 2 In addition, the LRI retrieves one or more financial institutions' reset-eligible loan data 30, which may comprise a database of customer identity and contact information as well as specific loan information for a given financial institution's customers who have loans that are determined to be reset-eligible by the financial institution. Based on this retrieved data, which may be in the form of a spreadsheet or table uploaded by the financial institution, the LRI system, as indicated in block 40, may perform processing including: (A) interfacing with the financial institution devices and customer devices, via the communication portion over an electronic network, to establish the electronic session between the processor, financial institution devices, and customer devices; (B) retrieves reset-eligible loan/customer data from financial institution devices; (C) for each customer in the reset-eligible loan/customer data, generates a customer-specific proposed rate reset offer and generates a unique, customer-specific, locator identifier associated with each proposed rate reset offer for each customer; (D) facilitates communication of the proposed rate reset offer and unique locator identifier to each customer; (D) facilitates engagement of the customer with the LRI using the unique locator identifier; and performs processing related to the establishment of the new loan with interested customers.

The CRC LRI system 100.1 may perform processing 42 to generate a customer-specific loan reset offer for each loan provided in the financial reset-eligible loan data. The system 100.1 may further generate a unique locator identifier, such as a uniform resource locator (URL) which permits a customer to link to a particular location or data set within the CRC LRI system, where customer-specific loan reset offer may be retrieved and presented to the customer. The system 100.1 further may provide the identifier in an encrypted form and provide a key to the customer to enable decryption when the customer uses the encrypted locator.

FIG. 17 is a schematic diagram of a financial system that includes a CRC LRI system 100.1, in accordance with one embodiment of the invention. The CRC LRI system 100.1 performs processing associated with both the reset of a loan and interfacing with the customer in conjunction with effecting such reset of the loan, as described above with regard to FIGS. 1-15, as well as processing associated with the facilitating of a customer retention campaign as will be described in detail below. Thus, the system 100.1 includes the definition and computation engines, mechanisms and portions described above relative to FIG. 2, details of which have been omitted in FIG. 17 for clarity, as well as additional processing elements that may include a customer retention campaign management engine 170 to generate customer-specific proposed loan reset offers and unique locator identifiers associated with each customer. The CRC LRI system 100.1 includes a communication portion 150.1 that performs processing to communicate with one or more financial institution devices 400, 410 and 420 through a wide area network (WAN) such as the Internet. Financial institution devices 400 may display interfaces to financial institution representatives to enable the uploading of one or more files containing reset-eligible loan and customer data and to display output information provided by the CRC LRI system, including locator identifiers and associated proposed loan offer information for each customer of the financial institution. One or more customer devices 200, 210 and 220 may communicate similarly with the communication portion 150.1 and may present graphical or textual information to the customers regarding proposed loan reset offers, including the unique locator information and information relating to an offered loan reset, as describe above.

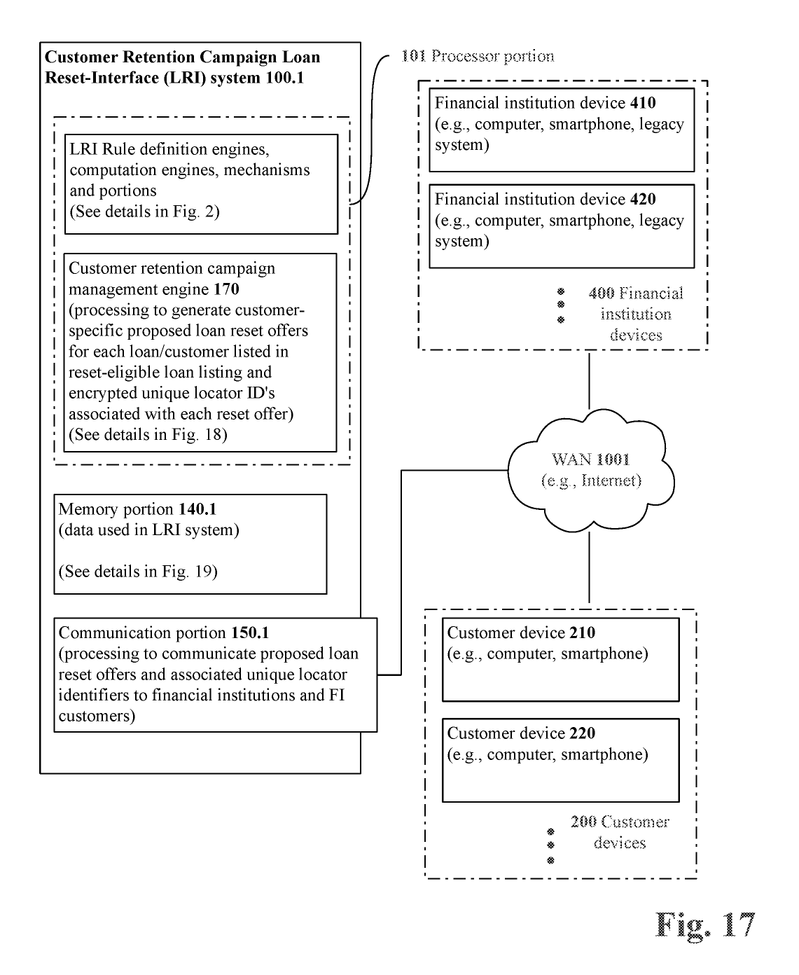

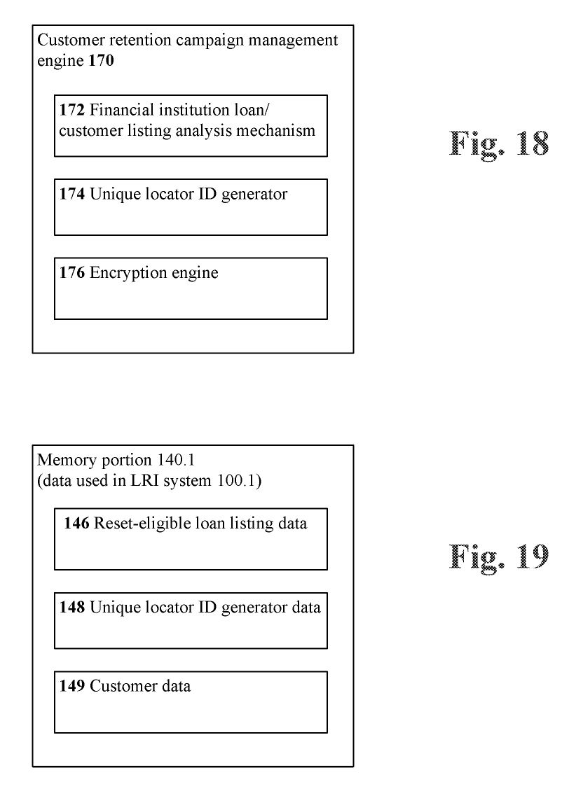

FIG. 18 and FIG. 19 are further schematic diagrams of the loan reset-interface system 100.1 of FIG. 17, in accordance an aspect of invention. In particular, FIG. 18 is a block diagram showing the customer retention campaign management engine 170 of the CRC LRI system 100, in accordance with one embodiment of the invention. Further, FIG. 19 is a block diagram showing the memory portion 140.1 of the system 100.1.

Further, FIG. 20 is high level flowchart showing processing performed by the CRC LRI system 100.1, in accordance with an aspect of the invention. Additionally, FIGS. 21-23 are further flowcharts showing the processing of FIG. 20 in further detail. Aspects of such processing are described below.

Referring to FIG. 17, the system 100.1 includes a customer retention campaign management engine 170. This processing element performs various processing associated with the customer retention campaign, including generating customer-specific loan reset offers and associated locator identifiers. As shown in FIG. 17, the system 100.1 includes a processor portion 101, i.e. a processor. The processor portion 101 handles a wide variety of processing performed by the system 100.1.

As described above, FIG. 18 is a block diagram showing further details of the customer retention campaign management engine 170, in accordance with one embodiment of the invention. The engine 170 may include a financial institution loan/customer listing analysis mechanism 172, which may analyze the data provided in the financial institutions loan/customer listing and pass it to the other processing elements, described above with regard to FIGS. 1-15, for example, in order to generate customer-specific loan rate reset offers. In addition, the engine 170 may include a unique locator generator 174 and encryption engine 176, for generating an encrypted form of the unique locator associated with each loan reset offer. Various further details of the CRC management engine 170 are described below.

The system 100.1 also includes a memory portion 140.1. The memory portion 140.1 stores a wide variety of data used in the system 100. In particular, the memory portion 140.1 stores data used by the customer retention campaign management engine 170 and the analytics portion 130. Further details of the memory portion 140 are described below with reference to FIG. 4.

FIG. 19 is a block diagram showing further details of the memory portion 140.1, in accordance with one embodiment of the invention. The memory portion 140.1 is provided to store various data used in operation of the loan reset-interface system 100.1. In addition to the data described with regard to FIG. 4, the memory portion 140.1 includes reset-eligible loan listing data 146 that may be retrieved from the financial institution's uploaded customer/loan data 30 (FIG. 16) and stored on a computer readable medium. Memory portion 140.1 may also include unique locator ID generator data 148 and customer data 149.

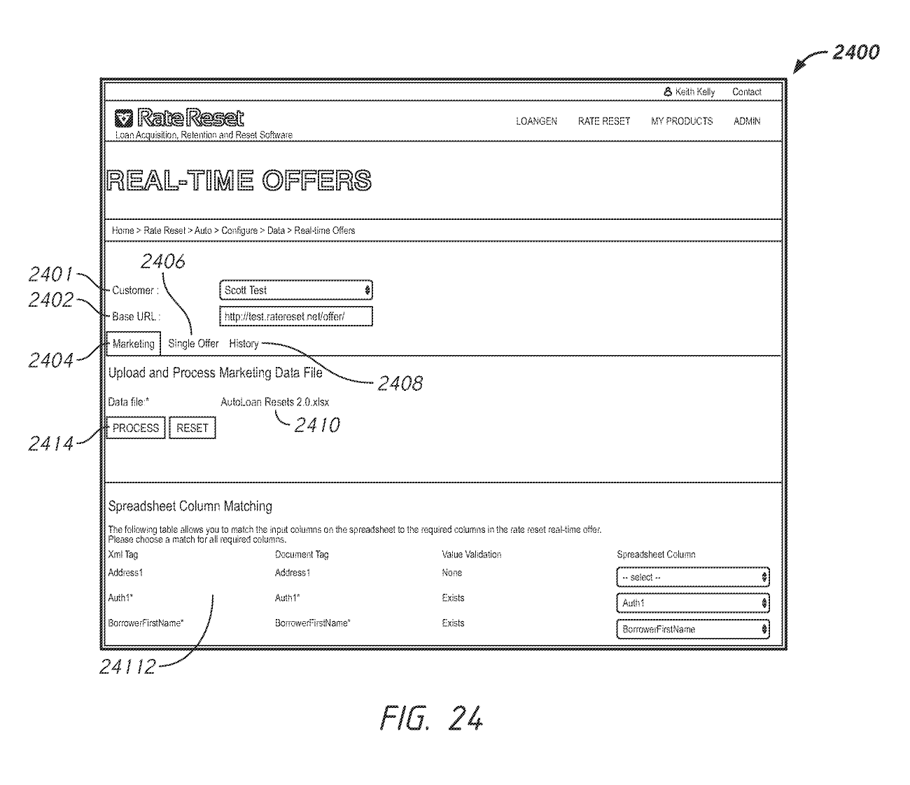

The CRC management engine 170 performs a variety of processing in addition and/or in conjunction with the processing described above. In particular, the CRC management engine 170 interfaces with financial institution device 400 (FIG. 17) to output various graphical displays to the device along with inputting responsive content back from the financial institution user. Such engagement with a user is described further below and in particular with reference to the flowcharts of FIGS. 20-23 and the processing shown therein, as well as the user interfaces of FIGS. 24-33. The communication portion 150.1 may be constituted by any suitable communication mechanism so as to transmit data from the loan reset-interface system 100.1 to the WAN 1001.

As described above, FIG. 20 is high level flowchart showing processing performed by the loan reset-interface system 100.1, in accordance with one embodiment of the invention. The processing of FIG. 20 starts in step 600, wherein the system 100.1 initiates customer retention campaign loan reset interface processing for the financial institution and financial institution customers.

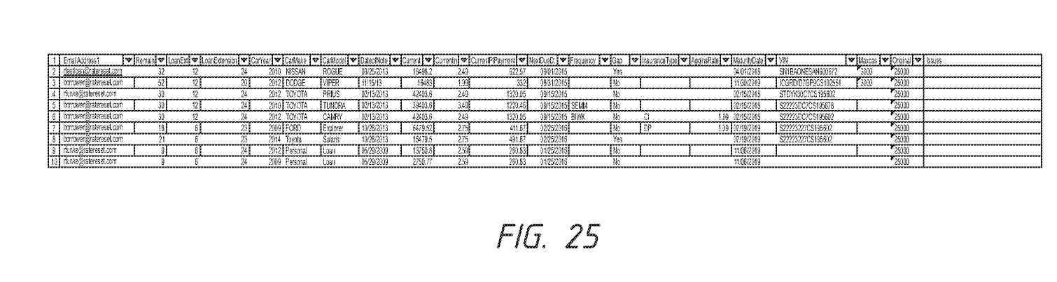

At step 610, the CRC LRI performs processing to retrieve reset eligible loan/customer data from a financial institution. This processing may include the display of an appropriate interface, such as that shown in FIG. 24, to prompt a financial institution representative to upload reset-eligible loan/customer data, for example, in a spreadsheet form depicted in FIG. 25. Suitable authentication and protocols may be provided, as is known. The system 100.1 performs processing to engage a customer regarding a loan reset. In general, the processing of step 610 relates to retrieving a variety of data and presenting various options to the financial institution representative regarding the retrieval of loan/customer data. In accordance with embodiments of the invention, the various options may be presented to the customer in the form of graphics and other data. Further details of the example process 610 are shown in FIG. 21, and may include a step 612 in which the system 100.1 is in a standby or waiting mode, constantly checking for user engagement with the system. At 614, a determination is made that an authenticated financial institution user has initiated engagement and wishes to upload customer/loan data. At 616, the system accesses or retrieves the loan/customer data. At 618, the sub-process returns to the main process step 620.

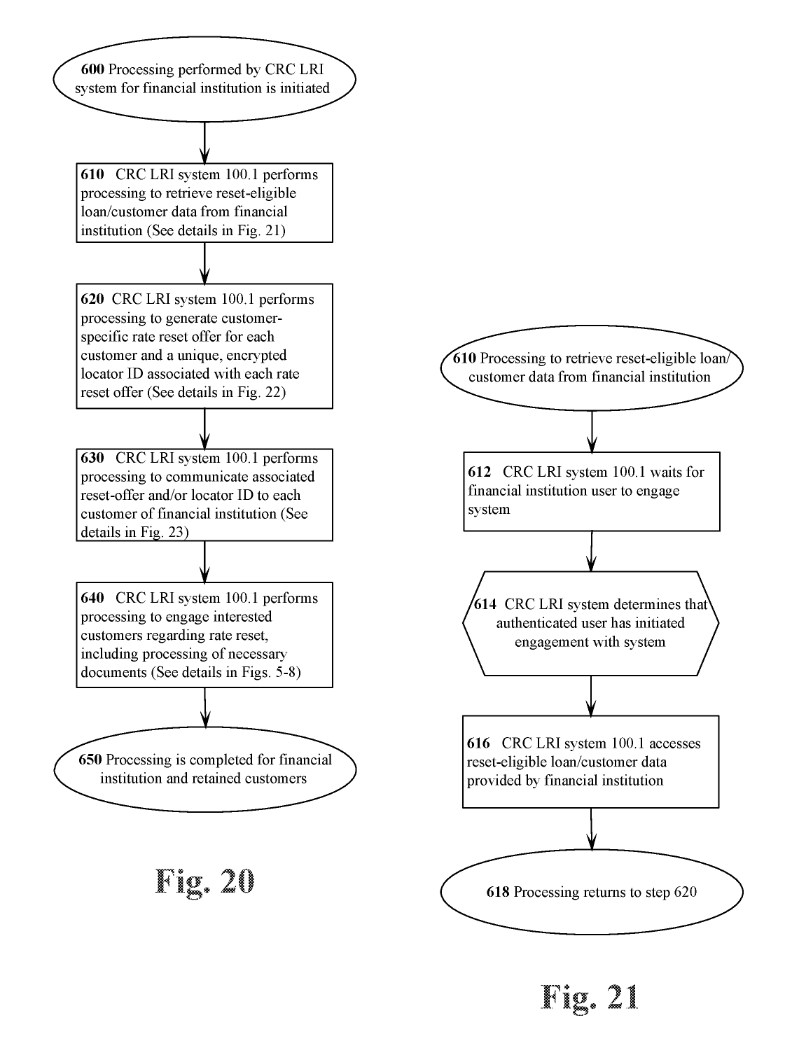

As shown in FIG. 20, after the processing of step 610, the process passes to step 620, in which the system 100.1 performs processing to generate a customer-specific rate reset offer for each customer/loan represented in the loan data 30 (FIG. 16). Further details of this main process step are shown in sub-process of FIG. 22. At 621, the system retrieves the first (or next) customer and loan data from the table or other data that was uploaded or retrieved in step 610. At 622, the system generates a customer-specific proposed loan rate reset based on the current loan data. As will be recognized, this step 622 may involve further sub-processes as detailed with regard to FIGS. 5-8 above, except that the data input by a customer in those steps may be retrieved from the uploaded table or customer loan data 30 (FIG. 16). At 623, the system generates a customer-specific unique locator identifier and associates the same with the prospect loan data. At 624, the system stores the prospect loan data and unique locator for that specific customer for later retrieval. At 625, the system determines whether or not the end of he customer data file is reached. If so, processing proceeds to step 626 where the sub-process returns control to the main process at step 630. If not, the process returns to step 621 to repeat the steps 621 to 625 for the next customer data.

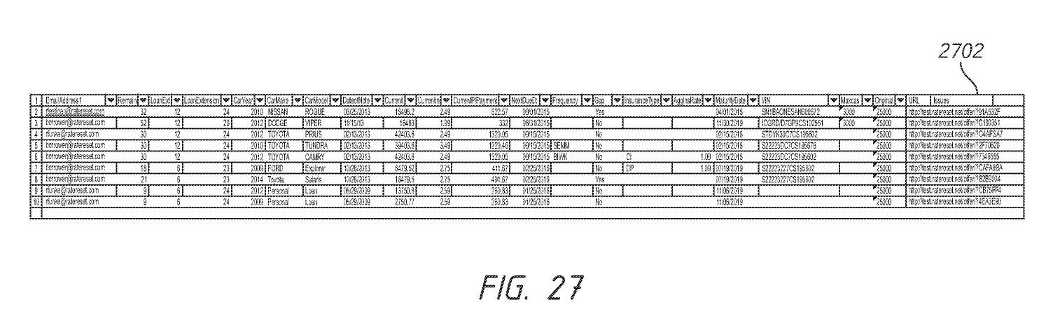

After step 620, the process passes to step 630, where the system performs steps to communicate associated reset offers and locator identifiers to respective customers of the financial institution. As will be recognized, this step may occur using automated emailing processes and templates, or may involve steps of manual control and verification by a financial institution representative. At step 631, the system retrieves contact information, such as an email address, for the next customer. At 632, the unique locator identifier associated with that customer is retrieved, as is the prospect loan data. At step 634, the system may generate a template message, such as that depicted in FIGS. 27-29, to be emailed or transmitted to the specific customer. At 635, the system may optionally permit a financial institution representative to manually compose a message and send a single locator ID and prospect loan data to a single customer. At 636, the system determines whether or not the end of the data is reached. If so, control returns to step 640 at 637. If not, the process repeats steps 631 to 636 for the next set of customer data in the uploaded financial institution loan/customer data.

At step 640 (FIG. 20) the system 100.1 performs processing to engage interested customers, i.e., those who received and utilized the unique identifier to engage the system in the manner described above relative to FIGS. 5-8. As will be recognized, this engagement may include steps to provide real-time document review and execution to the customer such that the completion or closing of a proposed loan reset offer with a given customer can take place quickly (and enable the customer to disengage from any other transaction with a third-party that might result in the financial institution's loss of the loan). At step 650, processing is completed for the financial institution, hopefully with a number of its customers choosing to accept respective proposed reset offers and forego refinance or other transactions that might cause the institution to lose the loan.

FIGS. 24-33 illustrate example user interfaces and data files according to aspects of the disclosure. FIG. 24 illustrates a user interface for facilitating the generation of real-time offers. The interface may include a CUSTOMER field 2401 for inputting a customer identifier and a BASE URL field 2402 for inputting a base URL string to be utilized in the generation of unique URL's. The interface may include tabs for MARKETING 2404, SINGLE OFFER 2406 and HISTORY 2408. A DATA FILE input field 2410 enables a user to input an identifier for an input file containing the data from which the real-time offers are to be generated. A PROCESS control button 2414 permits a user to initiate processing once the data file has been identified. A spreadsheet column matching interface 2412 may enable a user to match fields in an input data file in spreadsheet form to designated fields for data to be used for input to the system.

FIG. 25 illustrates the contents and structure of an example input data file according to aspects of the disclosure. While auto loan data is shown, it will be understood that other types of loans and loan data may be utilized within the scope of the disclosure. Input data for each loan may include customer contact data such as an email address or other contact information, loan information, such as information pertaining to the remaining months on the life of each loan, loan amount due, total loan amount, interest rate, payment amount, next due date and collateral identifying information, such as the year, make and model, VIN of the vehicle associated with the loan. Information regarding gap or other insurance related to the loan may also be identified and used in analysis and generation of reset offers.

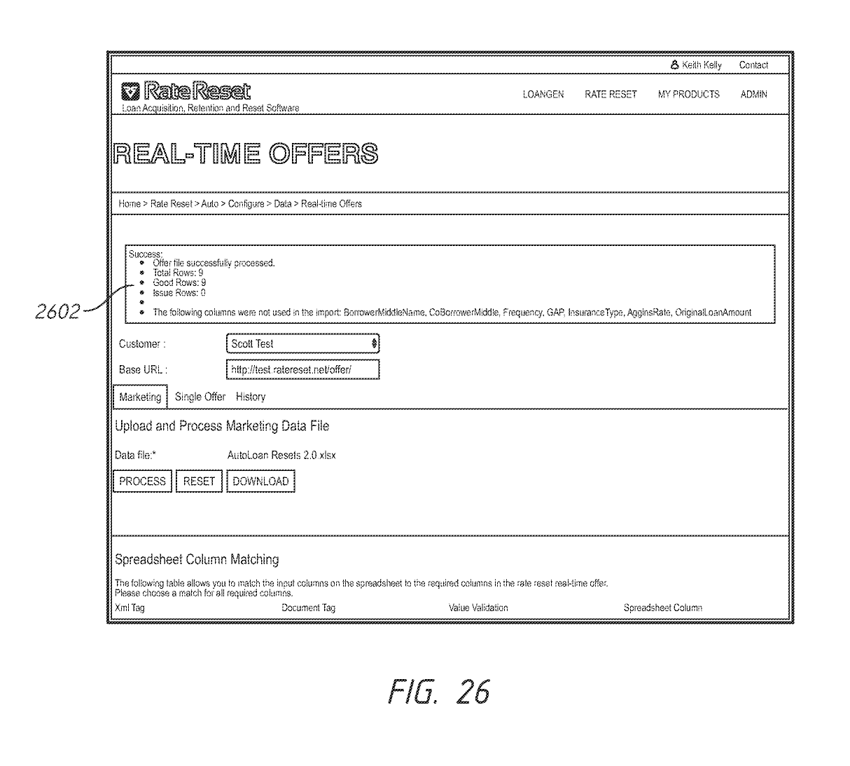

FIG. 26 illustrates an interface for confirming input and processing of an input data file. A status window 2602 relays information to the user following processing of the input file. The status window 2602 may include information regarding the number of records (rows) in the data file that were successfully processed and which resulted in offers being generated. The status window may also indicate whether or not any errors occurred during processing or may indicate any data fields that were or were not used in processing the input file.

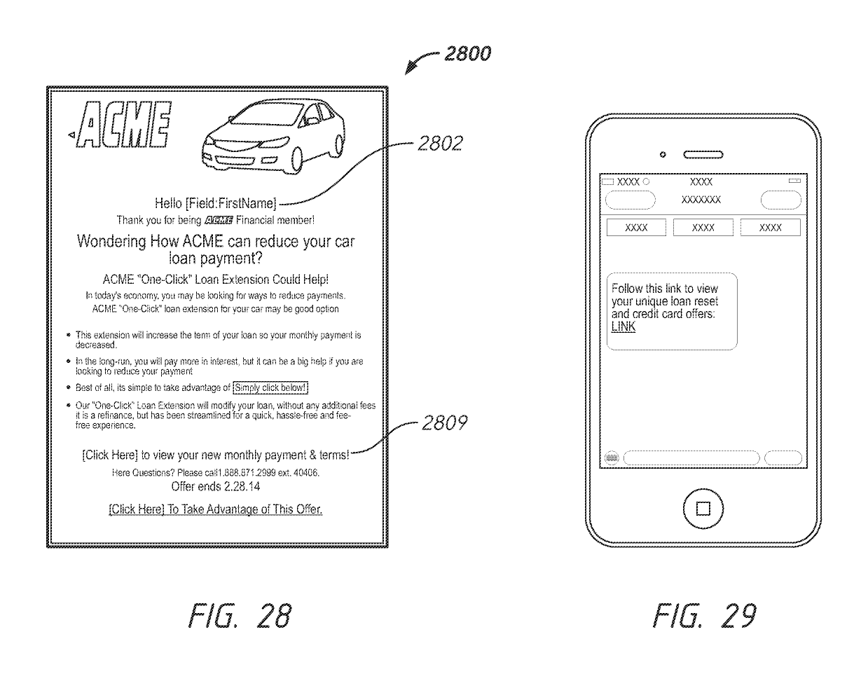

FIG. 27 illustrates the content and structure of example output data, which includes a unique URL column 2702 containing a unique URL that has been generated for each loan. The unique URL may be sent to the appropriate contact who may then access the particular reset offer generated by the system. FIG. 28 illustrates an example format of an offer message 2800 that may be sent electronically to a customer. The offer message 2800 may contain fields 2802 that are populated from the loan data to customize the message. According to an aspect of the disclosure, the offer message may contain an embedded link 2804 to the unique URL associated with the particular customer's reset offer, enabling the customer to immediately view and process the reset offer within the system. FIG. 29 illustrates a text message on a mobile device containing a unique URL for accessing a real-time reset offer.

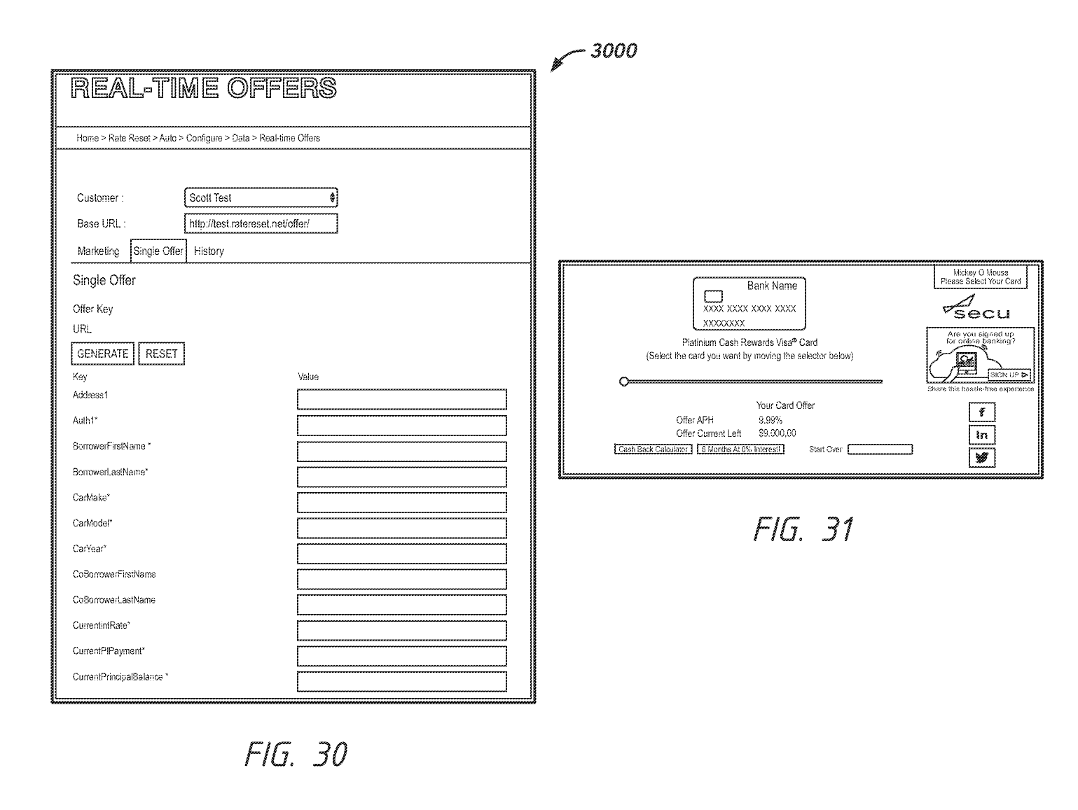

FIG. 30 illustrates another example interface 3000, in this case for inputting data to generate a single loan reset offer. Here, a user may input loan, borrower and vehicle information as indicated in various fields 3002 to generate a single reset offer. A single unique URL is generated and provided to the user. The URL may then be forwarded to an email or text or other contact point for the customer to enable the customer to review and process the single real-time reset offer.

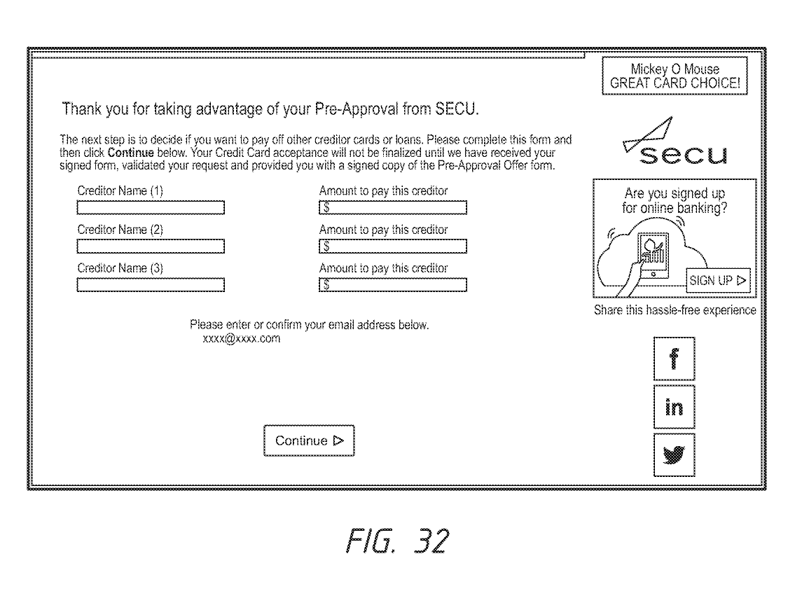

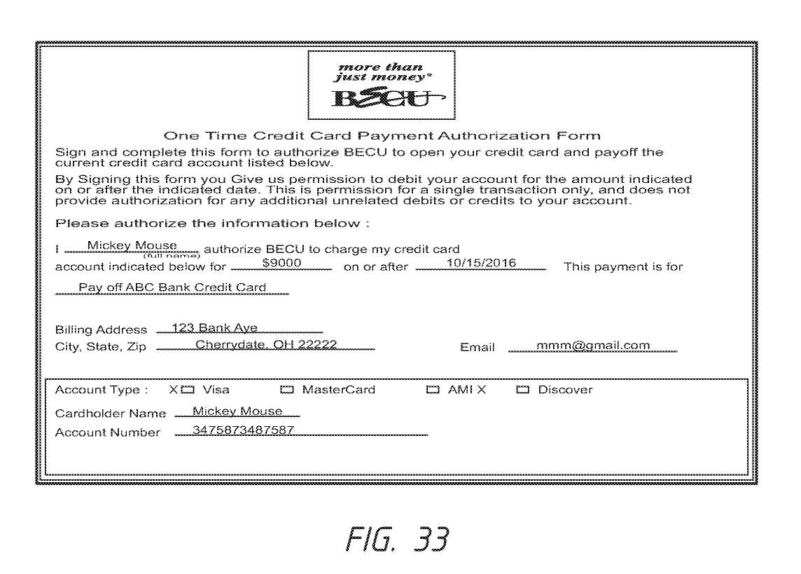

FIGS. 31-33 illustrate customer interfaces for pre-approved loan or credit card campaigns utilizing the advantages of aspects of the disclosure. Such campaigns are popular with banks and credit unions. The system described herein may be utilized to analyze and generate large numbers of pre-approved offers to customers, each being associated with a unique URL that may be utilized by a respective customer to review and accept a pre-approved loan or credit card in real-time. FIG. 31 illustrates an interface that may be accessed by a customer by navigating to the unique URL sent to that customer. The interface may contain a description of a pre-approved credit card offer. The the interface may permit the customer to select one among a number of cards being offered using a slide control within the message, with rate and credit limit information being indicated for each. Once a card is selected, an existing credit card data input screen may be displayed as shown in FIG. 32, enabling the customer to input information regarding current/existing creditors to be paid from the pre-approved loan/credit card. FIG. 33 illustrates an authorization interface to enable the customer to formally authorize payment of existing credit card accounts using the new loan/credit card.

It is appreciated that features of one embodiment as describe herein may be used in conjunction with other embodiments.

The described embodiments may be implemented as a system, method, apparatus or article of manufacture using standard programming and/or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention, the systems and methods use networks, wherein, the term, ‘networks’ means a system allowing interaction between two or more electronic devices, and includes any form of inter/intra enterprise environment such as the world wide web, Local Area Network (LAN), Wide Area Network (WAN), Storage Area Network (SAN) or any form of Intranet.

In an embodiment of the invention, the systems and methods can be practiced using any electronic device. An electronic device for the purpose of this invention is selected from any device capable of processing or representing data to a user and providing access to a network or any system similar to the internet, wherein the electronic device may be selected from but not limited to, personal computers, mobile phones, laptops, palmtops, portable media players and personal digital assistants.

As noted above, the processing machine used to implement the invention may be a suitable computer or other processing machine. The processing machine may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Windows 10 operating system, the Windows 8 operating system, Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, as also described above, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, as also described above, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A system that generates a plurality of loan reset offers for a like plurality of customers of a financial institution, the system comprises a processor coupled to a memory portion with the processor configured to execute programmed instructions stored in the memory portion, the processor performing processing including:
retrieving aggregate loan customer data that represents a plurality of reset-eligible loans;
generating a unique locator for each reset-eligible loan;
generating prospect loan data sets based on each of the reset-eligible loans
associating each unique locator with a respective one of the generated prospect loan data sets; and
receiving a request for one of the unique locators from a customer device;
in response to receiving the request, generating a prospect loan offer and outputting the prospect loan data to the customer device in the electronic communication session.

2. The system of claim 1, wherein the loan customer data is auto loan data.

3. The system of claim 1, wherein the loan customer data is home loan data.

4. The system of claim 2, wherein the auto loan data includes loan information pertaining to one of: the remaining months on the life of each loan, loan amount due, total loan amount, interest rate, payment amount, next due date and collateral identifying information, such as the year, make and model, VIN of the vehicle associated with the loan.

5. The system of claim 4, wherein the loan information includes information regarding gap or other insurance related to the loan.

6. The system of claim 3, wherein the home loan data includes loan information pertaining to one: the remaining months on the life of each loan, loan amount due, total loan amount, interest rate, payment amount, next due date and collateral identifying information.

7. The system of claim 1, wherein generating a unique locator for each reset-eligible loan comprises rendering at least one hypertext link presented to a user.

8. The system of claim 1, wherein generating a loan prospect offer comprises rendering graphics a customer including a link to the corresponding unique locator.

9. The system of claim 1, wherein generating a loan prospect offer comprises generating a plurality of pre-approved offers.

10. A method to generate a plurality of loan reset offers for a like plurality of customers of a financial institution, the method implemented on a system that comprises a processor coupled to a memory portion with the processor configured to execute programmed instructions stored in the memory portion, the method comprising:
retrieving aggregate loan customer data that represents a plurality of reset-eligible loans;
generating a unique locator for each reset-eligible loan;
generating prospect loan data sets based on each of the reset-eligible loans
associating each unique locator with a respective one of the generated prospect loan data sets; and
receiving a request for one of the unique locators from a customer device;
in response to receiving the request, generating a prospect loan offer and outputting the prospect loan data to the customer device in the electronic communication session.

11. A computer readable medium containing instructions that are implemented by a system to process a plurality of loan reset offers for a like plurality of customers of a financial institution, the system comprising a processor coupled to a memory portion with the processor configured to execute programmed instructions stored in the memory portion, the computer readable medium comprising:
a first portion that retrieves aggregate loan customer data that represents a plurality of reset-eligible loans;
a second portion that generates a unique locator for each reset-eligible loan;
a third portion that generates prospect loan data sets based on each of the reset-eligible loans
a fourth portion that associates each unique locator with a respective one of the generated prospect loan data sets; and
a fifth portion that receives a request for one of the unique locators from a customer device;
a sixth portion that, in response to receiving the request, generates a prospect loan offer and outputs the prospect loan data to the customer device in the electronic communication session.
